(19) United States
(12) Patent Application Publication
(10) Pub. No.: US 2026/0161108 A1
(43) Pub. Date: Jun. 11, 2026

(54) IMAGE FORMING APPARATUS

(71) Applicant: CANON KABUSHIKI KAISHA, Tokyo (JP)

(72) Inventors: KOHEI KOGUCHI, Tokyo (JP); TOMOYA TATEISHI, Kanagawa (JP); OSAMU SASAOKA, Kanagawa (JP)

(21) Appl. No.: 19/179,301

(22) Filed: Apr. 15, 2025

(30) Foreign Application Priority Data
Apr. 24, 2024 (JP) 2024-070298
Apr. 24, 2024 (JP) 2024-070299

(51) Int. Cl. G03G 15/01; G03G 21/00; G03G 21/12; G03G 21/16; G03G 21/18

(52) U.S. Cl. CPC G03G 15/0173; G03G 15/011; G03G 15/0131; G03G 21/0005; G03G 21/12; G03G 21/1676; G03G 21/1814; G03G 21/1828; G03G 2221/1654

(57) ABSTRACT

An image forming apparatus includes a photosensitive drum, an exposure device, a rotary including a developing roller, and an accommodating frame including an accommodating portion, and a toner cartridge, the toner cartridge being detachably attached to the rotary. The exposure device includes a casing and a passage portion which is provided in the casing and disposed below a rotation axis of the rotary and through which light emitted toward the photosensitive drum passes. The toner cartridge includes a toner discharge port through which the toner supplied to the accommodating portion of the rotary passes. A direction from a first side toward a second side in a rotation axis direction of the rotary is defined as a predetermined direction. A downstream end of the toner discharge port is positioned downstream of a downstream end of the passage portion in the predetermined direction.

### BACKGROUND OF THE INVENTION

### Field of the Invention

The present invention relates to an image forming apparatus that forms an image on a recording material.

### Description of the Related Art

A rotary development method for forming a color image by rotating a rotary including a plurality of developing members in an electrophotographic image forming apparatus has been known. According to Japanese Patent Application Publication No. 2007-183305 and Japanese Patent Application Publication No. 2008-096852, an image forming apparatus including a rotary including a plurality of developing rollers and a plurality of toner cartridges (toner containers) attachable to and detachable from the rotary is proposed.

### SUMMARY OF THE INVENTION

According to a first aspect of the present invention, an image forming apparatus includes a photosensitive drum, an exposure device configured to expose a surface of the photosensitive drum to form an electrostatic latent image on the surface, a rotary configured to rotate and including a developing roller configured to develop the electrostatic latent image as a toner image, and an accommodating frame including an accommodating portion configured to accommodate toner to be supplied to the developing roller, and a toner cartridge configured to accommodate the toner, move between a mounting position and a retracted position where the toner cartridge is retracted from the mounting position with respect to the accommodating frame, and supply the toner to the accommodating portion in a state of being at the mounting position, the toner cartridge being detachably attached to the rotary. The exposure device includes a casing and a passage portion which is provided in the casing and disposed below a rotation axis of the rotary and through which light emitted toward the photosensitive drum passes. The toner cartridge includes a toner discharge port through which the toner supplied to the accommodating portion of the rotary passes. A direction from a first side toward a second side in a rotation axis direction of the rotary is defined as a predetermined direction. A downstream end of the toner discharge port is positioned downstream of a downstream end of the passage portion in the predetermined direction.

According to a second aspect of the present invention, an image forming apparatus includes a photosensitive drum, an exposure device configured to expose a surface of the photosensitive drum to form an electrostatic latent image on the surface, a rotary configured to rotate and including a developing roller configured to develop the electrostatic latent image as a toner image, and an accommodating frame including an accommodating portion configured to accommodate toner to be supplied to the developing roller, a toner cartridge configured to accommodate the toner, move between a mounting position and a retracted position where the toner cartridge is retracted from the mounting position with respect to the accommodating frame, and supply the toner to the accommodating portion in a state of being at the mounting position, the toner cartridge being detachably attached to the rotary, a collection member configured to collect waste toner adhering to the photosensitive drum after the toner image is transferred from the photosensitive drum, and a waste toner accommodating portion configured to accommodate the waste toner collected by the collection member. The waste toner accommodating portion is arranged so as to at least partially overlap the exposure device when viewed in a rotation axis direction of the photosensitive drum.

According to a third aspect of the present invention, an image forming apparatus includes a first process unit including a first photosensitive drum, a first developing unit configured to develop a first electrostatic latent image formed on the first photosensitive drum as a first toner image, a first collection member configured to collect waste toner adhering to the first photosensitive drum after the first toner image is transferred from the first photosensitive drum, and a first waste toner accommodating portion configured to accommodate the waste toner collected by the first collection member, a second process unit including a second photosensitive drum, a second developing unit configured to develop a second electrostatic latent image formed on the second photosensitive drum as a second toner image, a second collection member configured to collect waste toner adhering to the second photosensitive drum after the second toner image is transferred from the second photosensitive drum, and a second waste toner accommodating portion configured to accommodate the waste toner collected by the second collection member, an exposure device configured to expose the first photosensitive drum and the second photosensitive drum to form the first electrostatic latent image and the second electrostatic latent image, and an intermediate transfer unit including an intermediate transfer body, a first transfer roller configured to transfer the first toner image to the intermediate transfer body, and a second transfer roller configured to transfer the second toner image to the intermediate transfer body. The first waste toner accommodating portion and the second waste toner accommodating portion are each arranged so as to at least partially overlap the exposure device when viewed in a rotation axis direction of the first photosensitive drum.

Further features of the present invention will become apparent from the following description of exemplary embodiments with reference to the attached drawings.

### BRIEF DESCRIPTION OF THE DRAWINGS

FIG. 1 is a schematic view of an image forming apparatus according to a first embodiment.

FIG. 2 is a configuration diagram of the image forming apparatus according to the first embodiment.

FIG. 3 is a schematic view of a developing unit, a toner cartridge, and a tray according to the first embodiment.

FIG. 4A is a cross-sectional view of the image forming apparatus according to the first embodiment.

FIG. 4B is a cross-sectional view of the image forming apparatus according to the first embodiment.

FIG. 5 is a perspective view of a rotary body according to the first embodiment.

FIG. 6A is a perspective view of the image forming apparatus according to the first embodiment.

FIG. 6B is a perspective view of the image forming apparatus according to the first embodiment.

FIG. 6C is a perspective view of the image forming apparatus according to the first embodiment.

FIG. 7A is a cross-sectional view of the image forming apparatus according to the first embodiment.

FIG. 7B is a cross-sectional view of the image forming apparatus according to the first embodiment.

FIG. 8 is an explanatory view of the rotary body according to the first embodiment.

FIG. 9 is an explanatory view of the rotary body according to the first embodiment.

FIG. 10 is an explanatory view of the rotary body according to the first embodiment.

FIG. 11A is an explanatory view of a configuration related to movement of the tray according to the first embodiment.

FIG. 11B is an explanatory view of the configuration related to the movement of the tray according to the first embodiment.

FIG. 12A is an explanatory view of a configuration related to movement of the tray according to the first embodiment.

FIG. 12B is an explanatory view of the configuration related to the movement of the tray according to the first embodiment.

FIG. 13A is a cross-sectional view illustrating a cross-sectional configuration of the image forming apparatus according to the first embodiment.

FIG. 13B is a cross-sectional view illustrating the cross-sectional configuration of the image forming apparatus according to the first embodiment.

FIG. 14 is a perspective view illustrating an intermediate transfer unit, a cleaning unit, and a scanner according to the first embodiment.

FIG. 15 is a front view illustrating the cleaning unit and the scanner according to the first embodiment.

FIG. 16A is an explanatory view illustrating a support configuration of the scanner according to the first embodiment.

FIG. 16B is an explanatory view illustrating the support configuration of the scanner according to the first embodiment.

FIG. 17A is a cross-sectional view illustrating an image forming apparatus according to a first modified example.

FIG. 17B is a cross-sectional view illustrating an image forming apparatus according to a second modified example.

FIG. 18 is a perspective view illustrating the scanner and the toner cartridge according to the first embodiment.

FIG. 19 is a plan view illustrating a passage portion of the scanner according to the first embodiment.

FIG. 20 is a side view illustrating the scanner and the toner cartridge according to the first embodiment.

FIG. 21 is a cross-sectional view illustrating a cross section taken along 21A-21A of FIG. 20 according to the first embodiment.

FIG. 22 is a cross-sectional view illustrating a cross section taken along 21A-21A of FIG. 20 according to a second embodiment.

### DESCRIPTION OF THE EMBODIMENTS

Hereinafter, embodiments according to the present disclosure will be described with reference to the drawings.

### First Embodiment

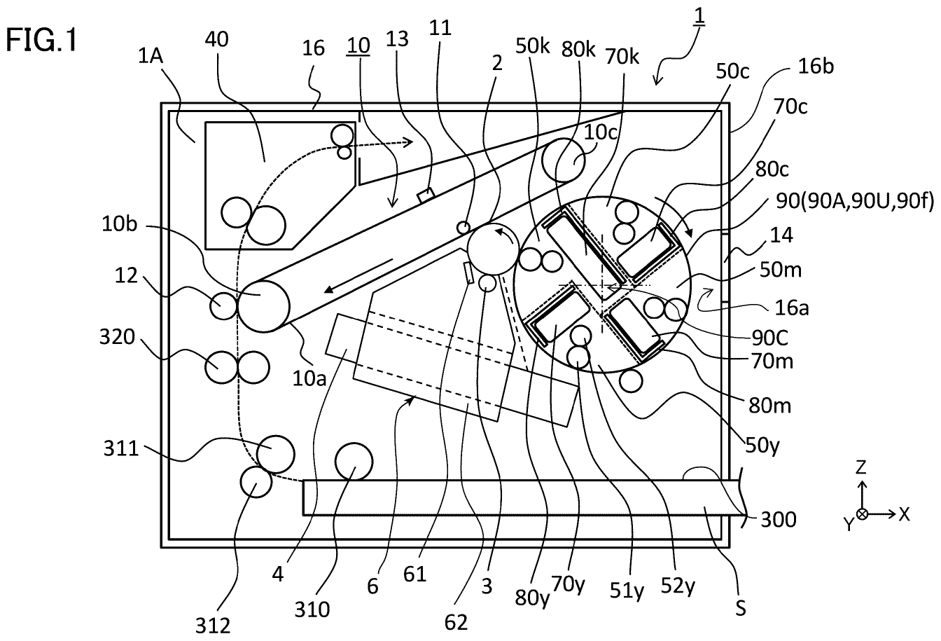

An image forming apparatus 1 according to a first embodiment will be described with reference to FIGS. 1 to 12A and 12B. In the following description and the respective drawings, a vertical direction in a case where the image forming apparatus 1 is installed on a horizontal plane is defined as a Z direction. A direction that intersects the Z direction and is a direction of a rotation axis 90C of a rotary body 90 described below (a rotation axis direction of a rotary) is defined as a Y direction. A direction of a rotation axis of a photosensitive drum 2 (a rotation axis direction of the photosensitive drum) is parallel to the direction of the rotation axis 90C of the rotary body 90, and is the Y direction. A direction intersecting both the Z direction and the Y direction is defined as an X direction. The X direction and the Y direction are preferably horizontal directions. The X direction, the Y direction, and the Z direction are preferably orthogonal to one another. Further, directions of arrows X, Y, and Z illustrated in the respective drawings are represented as a +X side, a +Y side, and a +Z side, respectively, and opposite sides thereof are represented as a −X side, a −Y side, and a −Z side, respectively, as necessary.

### Overall Configuration of Image Forming Apparatus

First, an overall configuration of the image forming apparatus 1 will be described. The image forming apparatus 1 is a laser beam printer that forms an image on a sheet S by an electrophotographic system. More specifically, the image forming apparatus 1 is a color laser beam printer including four developing units 50y, 50m, 50c, and 50k. As the sheet S serving as a recording material (recording medium), various sheet materials having different sizes and materials, for example, paper such as plain paper or thick paper, a sheet material subjected to surface treatment such as coated paper, and a sheet material having a special shape such as an envelope or index paper, can be used.

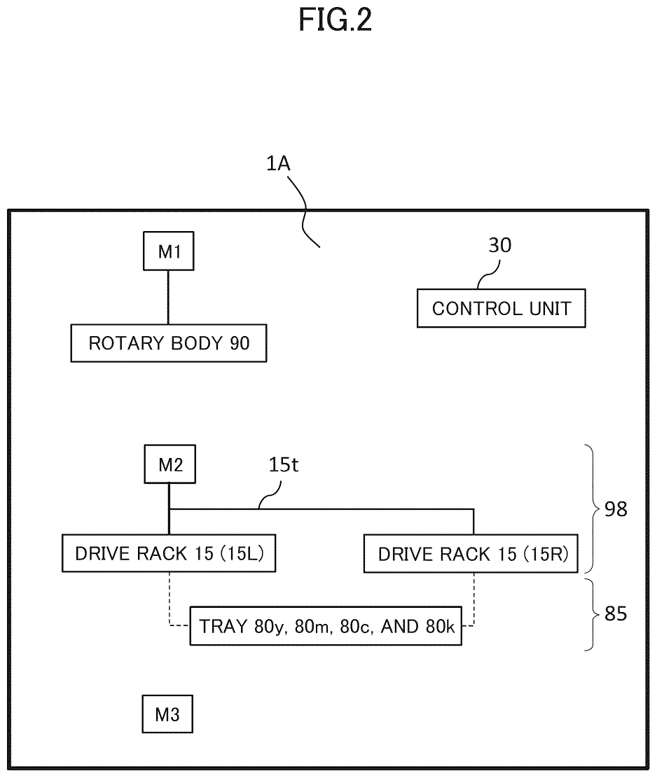

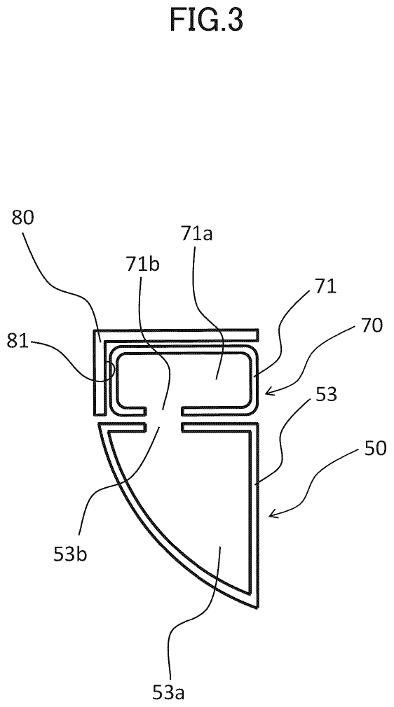

A schematic configuration and an image forming operation of the image forming apparatus 1 will be described with reference to FIGS. 1, 2, and 3. FIG. 1 is a schematic view illustrating a cross-sectional configuration of the image forming apparatus 1. FIG. 2 is a diagram illustrating a driving source of the image forming apparatus 1. FIG. 3 is a conceptual diagram illustrating a configuration for resupplying a toner from a toner cartridge 70 to the developing unit 50.

As illustrated in FIG. 1, the image forming apparatus 1 includes an image forming apparatus body (hereinafter, referred to as apparatus body) 1A and toner cartridges 70y, 70m, 70c, and 70k attachable to and detachable from the apparatus body 1A. The apparatus body 1A according to the present embodiment is a portion of the image forming apparatus 1 excluding the toner cartridges 70y, 70m, 70c, and 70k.

The apparatus body 1A of the image forming apparatus 1 includes the electrophotographic photosensitive member (hereinafter, referred to as photosensitive drum) 2 having a drum shape (cylindrical shape) as an image bearing member that bears an electrostatic latent image. A charging roller 3, a scanner 4 serving as an exposure device, and a cleaning unit 6 are disposed around the photosensitive drum 2.

The charging roller 3 is an example of a charging portion or a charging unit for uniformly charging the photosensitive drum 2. The scanner 4 is an example of an exposure portion or an exposure unit that irradiates the photosensitive drum 2 with laser light corresponding to image information to perform exposure. By irradiating the charged photosensitive drum 2 with the laser light, the electrostatic latent image is formed on a surface of the photosensitive drum 2. The cleaning unit 6 includes a cleaning blade 61 that removes the toner remaining on the surface of the photosensitive drum 2, and a waste toner accommodating portion 62 that accommodates a waste toner removed from the surface of the photosensitive drum 2 by the cleaning blade 61. A positional relationship between the cleaning unit 6 and the scanner 4 will be described below.

Further, the apparatus body 1A includes a sheet accommodating portion 300, a pickup roller 310, a feed roller 311, a separation roller 312, a conveyance roller pair 320, a secondary transfer roller 12, a fixing device 40, and an intermediate transfer unit 10. The pickup roller 310 is an example of a feeding portion or a feeding unit that feeds the sheet S. The feed roller 311 and the separation roller 312 are examples of a separation conveyance unit that conveys the sheet S while separating the sheets S one by one by a frictional force. The secondary transfer roller 12 is an example of a transfer portion or a transfer unit that transfers an image from an intermediate transfer belt 10a to the sheet S.

The intermediate transfer unit 10 includes the intermediate transfer belt 10a, a belt driving roller 10b, a tension roller 10c, a cleaning device 13, and a primary transfer roller 11. The intermediate transfer belt 10a is an example of an intermediate transfer body that bears the image to be transferred (primarily transferred) from the photosensitive drum 2 and conveys the image to be transferred (secondarily transferred) to the sheet S. The intermediate transfer belt 10a is stretched around the belt driving roller 10b and the tension roller 10c. The belt driving roller 10b is a driving member that conveys the intermediate transfer belt 10a by being rotationally driven by the driving source.

In addition, the apparatus body 1A includes the rotary body (rotary, rotary member, or developing device) 90 including the developing units 50y, 50m, 50c, and 50k. As described below, in the present embodiment, trays (support members) 80y, 80m, 80c, and 80k are attached to the rotary body 90. The toner cartridges 70y, 70m, 70c, and 70k are detachably mounted on the trays 80y, 80m, 80c, and 80k.

In the following description, a plurality of members and the like having similar functions can be distinguished by being denoted by numbers. For example, one of the toner cartridges 70y, 70m, 70c, and 70k can be referred to as a first toner cartridge, one of the remaining three can be referred to as a second toner cartridge, one of the remaining two can be referred to as a third toner cartridge, and the last one can be referred to as a fourth toner cartridge. Similarly, one of the trays 80y, 80m, 80c, and 80k can be referred to as a first tray, one of the remaining three can be referred to as a second tray, one of the remaining two can be referred to as a third tray, and the last one can be referred to as a fourth tray. That is, one of the trays 80y to 80k is an example of a first support member, another one of the trays 80y to 80k is an example of a second support member, a still another one of the trays 80y to 80k is an example of a third support member, and the last one of the trays 80y to 80k is an example of a fourth support member. The numbers are merely used for convenience of description, and can be appropriately changed in principle.

The developing units (first to fourth developing units) 50y, 50m, 50c, and 50k are examples of a developing portion or a developing section that develops (visualizes) the electrostatic latent image formed on the photosensitive drum 2 into a toner image by using a toner of a corresponding color. Each of the developing units 50y, 50m, 50c, and 50k develops the electrostatic latent image formed on the photosensitive drum 2 by using a yellow toner, a magenta toner, a cyan toner, or a black toner. The developing units 50y, 50m, 50c, and 50k may be arranged in an order different from the order illustrated in FIG. 1.

The developing unit 50y includes a developing roller 51y, a supply roller 52y, and a developing blade. The developing roller 51y is a developer bearer that bears the toner serving as a developer and rotates to supply the toner to the photosensitive drum 2. The supply roller 52y is a supply member that is disposed in contact with the developing roller 51y and supplies the toner to the developing roller 51y. The developing blade is a regulating member that regulates a thickness of a toner layer borne on the developing roller 51y. The other developing units 50m, 50c, and 50k also include similar developing rollers 51m, 51c, and 51k, supply rollers 52m, 52c, and 52k, and developing blades, respectively.

The toner cartridges 70y, 70m, 70c, and 70k corresponding to the developing units 50y, 50m, 50c, and 50k are mounted on the rotary body 90. The yellow toner, the magenta toner, the cyan toner, and the black toner are accommodated in the toner cartridges 70y, 70m, 70c, and 70k as toners to be resupplied to the developing units 50y, 50m, 50c, and 50k, respectively. One of the four color toners can be referred to as a first toner, one of the remaining three color toners can be referred to as a second toner, one of the remaining two color toners can be referred to as a third toner, and the last toner can be referred to as a fourth toner. For example, it can be said that the black toner is an example of the first toner and the magenta toner is an example of the second toner. The numbers are merely used for convenience of description, and can be appropriately changed in principle.

Here, the rotary body 90 includes a rotary frame body 90f that supports the developing units 50y, 50m, 50c, and 50k. The developing units 50y, 50m, 50c, and 50k are supported by the rotary frame body 90f that is a rotatable rotary support.

The trays 80y, 80m, 80c, and 80k are attached to the rotary body 90. A combined portion of the rotary body 90 and the trays 80y, 80m, 80c, and 80k can be referred to as a rotary unit 90U. In other words, the rotary unit 90U includes the rotary body 90 and the trays 80y, 80m, 80c, and 80k.

The toner cartridges 70y to 70k are detachably held by the trays 80y to 80k. As described below, the trays 80y to 80k are supported so as to be slidable to the outside of the rotary body 90. A combined portion of the rotary unit 90U and the toner cartridges 70y, 70m, 70c, and 70k can be referred to as a rotary assembly 90A. In other words, the rotary assembly 90A includes the rotary unit 90U and the toner cartridges 70y, 70m, 70c, and 70k.

As described below, the rotary body 90 is rotatable around the rotation axis (rotation center) 90C. The rotation axis 90C coincides with rotation axes of the rotary frame body 90f, the rotary unit 90U, and the rotary assembly 90A. The rotation axis 90C is substantially parallel to the rotation axis (rotation center) of the photosensitive drum 2.

The rotary body 90 can rotate around the rotation axis 90C to take a developing posture in which any one of the developing rollers 51y, 51m, 51c, and 51k faces the photosensitive drum 2. A posture in which the developing roller 51y faces the photosensitive drum 2 is referred to as a yellow developing posture. A posture in which the developing roller 51m faces the photosensitive drum 2 is referred to as a magenta developing posture. A posture in which the developing roller 51c faces the photosensitive drum 2 is referred to as a cyan developing posture. A posture in which the developing roller 51k faces the photosensitive drum 2 is referred to as a black developing posture. That is, the rotary body 90 can rotate around the rotation axis 90C so as to change positions of the developing rollers 51y, 51m, 51c, and 51k with respect to the photosensitive drum 2. The black developing posture is an example of a first developing posture in which a first developing roller (developing roller 51k) faces the photosensitive drum 2. Other developing postures are examples of a second developing posture in which a second developing roller (the developing roller 51y, 51m, or 51c) faces the photosensitive drum 2. The yellow/magenta/cyan/black developing postures can also be referred to as first to fourth developing postures. The numbers are merely used for convenience of description, and can be appropriately changed in principle.

As illustrated in FIG. 2, the apparatus body 1A includes motors M1, M2, and M3 serving as the driving sources. As described below, the motor M1 supplies a driving force for rotating the rotary body 90 around the rotation axis 90C. In other words, the motor M1 rotates the rotary assembly 90A and the rotary unit 90U around the rotation axis 90C.

The apparatus body 1A includes a driving device 98 including the motor M2 and a transmission device. The transmission device includes drive racks 15L and 15R serving as driving gears described below, and a transmission unit 15t. A driving force of the motor M2 is transmitted to the drive racks 15L and 15R by the transmission unit 15t. In other words, the motor M2 is configured to drive the drive racks 15L and 15R, and moves the trays 80y, 80m, 80c, and 80k with respect to the rotary body 90 via the drive racks 15L and 15R.

The motor M3 drives members other than the members driven by the motor M1 and the motor M2. For example, the motor M3 drives the photosensitive drum 2, the developing units 50y, 50m, 50c, and 50k, the pickup roller 310, the feed roller 311, the conveyance roller pair 320, the secondary transfer roller 12, the belt driving roller 10b, and the fixing device 40.

The members driven by the motors M1, M2, and M3 can be appropriately changed. Any two or all three roles of the motors M1, M2, and M3 can be integrated into one motor. Meanwhile, a driving source other than the motors M1, M2, and M3 may also be added.

Furthermore, the apparatus body 1A includes a control unit 30 serving as a control unit that controls an operation of the image forming apparatus 1. The control unit 30 includes a central processing unit (CPU) that executes a program and a storage unit such as a read only memory (ROM) or a random access memory (RAM). The CPU reads and executes a program stored in the storage unit, and controls operations of actuators such as the motors M1, M2, and M3 provided in the image forming apparatus 1. The storage unit includes a nonvolatile storage medium and a volatile storage medium, and serves as a storage location for programs and data and a work space when the CPU executes a program. Each function of the control unit 30 described below may be implemented in a circuit in the control unit 30 as independent hardware such as an application-specific integrated circuit (ASIC).

Here, subscripts y, m, c, and k attached to the developing units 50y, 50m, 50c, and 50k, the toner cartridges 70y, 70m, 70c, and 70k, the trays 80y, 80m, 80c, and 80k, and the like indicate toner colors. Basic configurations and functions of the developing units 50y, 50m, 50c, and 50k are common. Basic configurations and functions of the toner cartridges 70y, 70m, 70c, and 70k are common. Further, basic configurations and functions of the trays 80y, 80m, 80c, and 80k are common. Therefore, in a case where it is not necessary to distinguish the four units, the four cartridges, and the four trays, the subscripts y, m, c, and k are omitted, and description will be made assuming that the corresponding member is any one of the four units, the four cartridges, or the four trays. On the other hand, in a case of distinguishing the four units, the four cartridges, and the four trays, the subscripts y, m, c, and k are added, and description will be made assuming that the corresponding member is one of the four units, the four cartridges, or the four trays that corresponds to the subscript of the corresponding member.

As illustrated in FIG. 3, the toner cartridge 70 includes a toner frame body 71. The toner frame body 71 includes a toner accommodating portion 71a that accommodates the toner and a discharge opening 71b that communicates with the toner accommodating portion 71a.

The developing unit 50 includes a developing frame body (accommodating frame) 53. The developing frame body 53 includes a developing side accommodating portion 53a (accommodating portion) and a reception opening 53b that communicates with the developing side accommodating portion (toner supply chamber) 53a. That is, the rotary body 90 includes a developing frame body 53y, a developing frame body 53m, a developing frame body 53c, and a developing frame body 53k. That is, the rotary body 90 includes a first developing chamber, a second developing chamber, a third developing chamber, and a fourth developing chamber. As described above, the developing unit 50 includes the developing roller 51, the supply roller 52, and the like, but such members are omitted in FIG. 3.

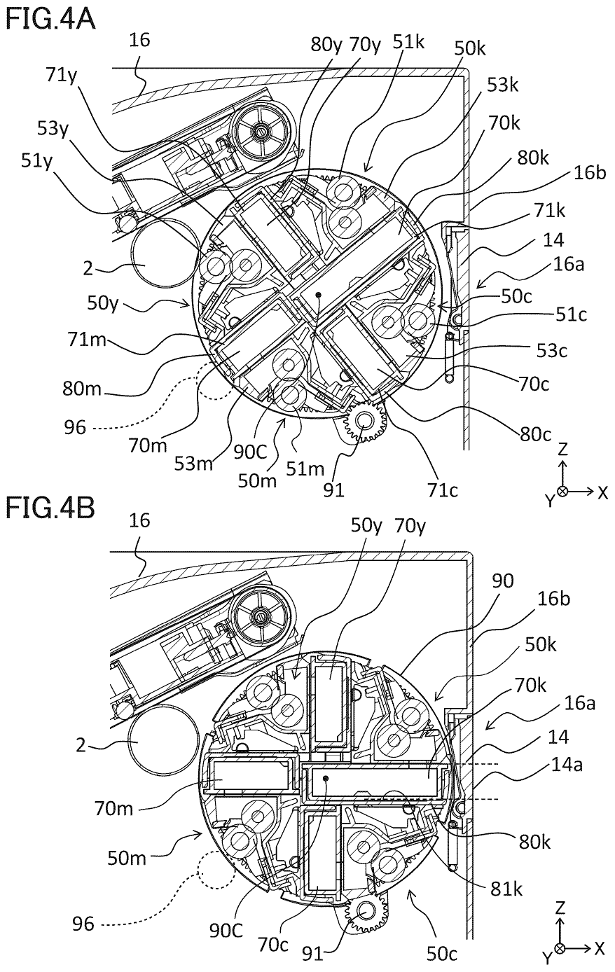

The developing roller 51k included in the developing unit 50k is an example of the first developing roller. The developing roller 51m included in the developing unit 50m is an example of the second developing roller. The developing frame body 53k (FIG. 4A) of the developing unit 50k including the developing side accommodating portion 53a is an example of a first accommodating frame including a first accommodating portion. The developing frame body 53m (FIG. 4A) of the developing unit 50m including the developing side accommodating portion 53a is an example of a second accommodating frame including a second accommodating portion. The rotary body 90 is an example of a rotatable rotary including the first developing roller, the second developing roller, the first accommodating frame including the first accommodating portion, and the second accommodating frame including the second accommodating portion. In the present embodiment, the rotary body 90 includes the first to fourth developing rollers and the first to fourth housing frame bodies.

As described below, the toner cartridge 70 is movable with respect to the developing frame body 53 to a mounting position and a retracted position where the toner cartridge 70 is retracted from the mounting position. In a state in which the toner cartridge 70 is at the mounting position with respect to the developing frame body 53, the discharge opening 71b faces the reception opening 53b. That is, the toner accommodating portion 71a of the toner cartridge 70 and the developing side accommodating portion 53a of the developing unit 50 communicate with each other via the discharge opening 71b and the reception opening 53b. When the toner is resupplied from the toner cartridge 70 to the developing unit 50, at least a part of the reception opening 53b is positioned below at least a part of the discharge opening 71b.

Then, the toner accommodated in the toner accommodating portion 71a is discharged through the discharge opening 71b, and the toner discharged through the discharge opening 71b is accommodated in the developing side accommodating portion 53a through the reception opening 53b. That is, a first developer is supplied to the first developing chamber included in the rotary body 90, a second developer is supplied to the second developing chamber, a third developer is supplied to the third developing chamber, and a fourth developer is supplied to the fourth developing chamber.

The toner accommodated in the developing side accommodating portion 53a is supplied to the developing roller 51 by the supply roller 52. The toner accommodated in the toner accommodating portion 71a is supplied to the developing roller 51 along such a path.

The toner cartridge 70 desirably includes a sealing member (first sealing member) (not illustrated) that covers the discharge opening 71b. In addition, the developing unit 50 desirably includes a sealing member (second sealing member) (not illustrated) that covers the reception opening 53b.

In a state in which the toner cartridge 70 is not mounted on the developing unit 50, it is desirable that the discharge opening 71b and the reception opening 53b are covered by the respective sealing members to suppress outflow of the toner from the discharge opening 71b and the reception opening 53b.

### Image Forming Operation

The image forming operation in the present embodiment will be described. First, the photosensitive drum 2 is rotated in an arrow direction (counterclockwise) in FIG. 1 in synchronization with the rotation of the intermediate transfer belt 10a. Then, the surface of the photosensitive drum 2 is uniformly charged by the charging roller 3.

In a case of forming a color image on the sheet S, the rotary body 90 rotates in an arrow direction (clockwise) of FIG. 1 while supporting the developing units 50y, 50m, 50c, and 50k as follows. Then, an electrophotographic process is repeatedly performed while moving the developing rollers 51y, 51m, 51c, and 51k to developing positions one by one.

First, the scanner 4 emits the laser light based on image data corresponding to a yellow image to form an electrostatic latent image corresponding to the yellow image on the surface of the photosensitive drum 2. In parallel with the formation of the electrostatic latent image, the motor M1 rotates the rotary body 90, and the rotary body 90 takes the yellow developing posture. When the rotary body 90 takes the yellow developing posture, the developing roller 51y is at the developing position and develops the electrostatic latent image formed on the photosensitive drum 2 with the yellow toner.

Here, in the present embodiment, each of the developing rollers 51y, 51m, 51c, and 51k is an elastic roller coated with rubber around a metal shaft. Each of the developing rollers 51y, 51m, 51c, and 51k develops the electrostatic latent image at the developing position in a state of being in contact with the photosensitive drum 2. That is, the image forming apparatus 1 according to the present embodiment employs a contact development method. However, each of the developing rollers 51y, 51m, 51c, and 51k may develop the electrostatic latent image at the developing position in a state in which a gap is formed between the photosensitive drum 2 and each of the developing rollers 51y, 51m, 51c, and 51k. That is, the image forming apparatus 1 may adopt a non-contact development method.

When the yellow toner image is developed, the yellow toner image on the photosensitive drum 2 is primarily transferred to the intermediate transfer belt 10a by the primary transfer roller 11 disposed on an inner side of the intermediate transfer belt 10a.

Thereafter, as the rotary body 90 is rotated to sequentially move the developing rollers 51m, 51c, and 51k to the developing positions, toner images of the respective colors are formed. That is, after the yellow toner image is formed on the intermediate transfer belt 10a, the rotary body 90 takes the magenta developing posture, and a magenta toner image is formed on the intermediate transfer belt 10a. After the magenta toner image is formed on the intermediate transfer belt 10a, the rotary body 90 takes the cyan developing posture, and a cyan toner image is formed on the intermediate transfer belt 10a. After the cyan toner image is formed on the intermediate transfer belt 10a, the rotary body 90 takes the black developing posture, and a black toner image is formed on the intermediate transfer belt 10a. After the black toner image is formed on the intermediate transfer belt 10a, the rotary body 90 rotates in the arrow direction (clockwise) illustrated in FIG. 1 around the rotation axis 90C and returns to the yellow developing posture. The color of the image formed first on the intermediate transfer belt 10a is arbitrary. For example, the black toner image may be formed first.

Then, the primary transfer is repeated so as to superimpose the toner images of four colors on the intermediate transfer belt 10a, whereby the color image is formed on the intermediate transfer belt 10a. The secondary transfer roller 12 and the cleaning device 13 do not come into contact with the intermediate transfer belt 10a until the color image is formed on the intermediate transfer belt 10a.

Meanwhile, the sheet S is fed by the pickup roller 310 from the sheet accommodating portion 300 provided at a lower portion of the apparatus body 1A. The sheet S is fed to the conveyance roller pair 320 in a state of being separated one by one by the feed roller 311 and the separation roller 312. The conveyance roller pair 320 feeds the fed sheet S to a transfer portion (secondary transfer portion) which is a nip portion between the intermediate transfer belt 10a and the secondary transfer roller 12. The color image on the intermediate transfer belt 10a is transferred (secondarily transferred) to a surface of the conveyed sheet S.

The sheet S to which the color image has been transferred is fed to the fixing device 40. In the fixing device 40, the sheet S is heated and pressurized, so that the image is fixed to the sheet S. The sheet S that has passed through the fixing device 40 is discharged to the outside of the image forming apparatus 1 as a product.

Meanwhile, in a case of forming a monochrome image on the sheet S, the rotary body 90 takes the black developing posture. In this state, the electrostatic latent image is formed on the surface of the photosensitive drum 2 by charging and exposure of the photosensitive drum 2, and then the electrostatic latent image is developed with the black toner by the developing roller 51k positioned at the developing position. The black toner image is primarily transferred to the intermediate transfer belt 10a and then secondarily transferred to the sheet S. The subsequent steps are similar to those in a case of the color image.

### Rotary Configuration

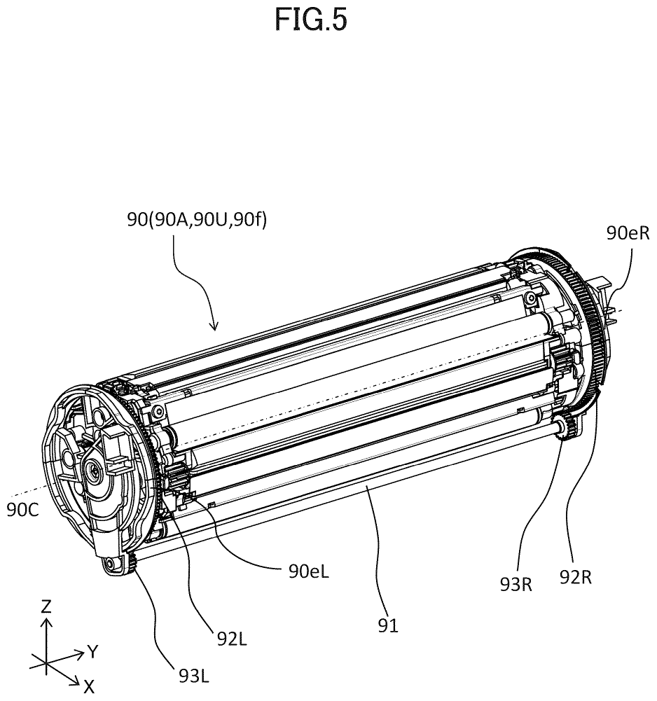

A configuration of the rotary body 90 will be described with reference to FIGS. 1, 4A, 4B, and 5. FIGS. 4A and 4B are cross-sectional views illustrating the rotary body 90 of the image forming apparatus 1 and the periphery thereof. FIGS. 4A and 4B are cross-sectional views of the apparatus taken along a virtual plane perpendicular to the rotation axis 90C of the rotary body 90. FIG. 5 is a perspective view of the rotary body 90.

As described above, the toner cartridges 70y to 70k are attachable to and detachable from the rotary body 90. In a case where the toners in the toner cartridges 70y to 70k have ran out, a user can resupply the toner to the image forming apparatus 1 by replacing the toner cartridges 70y to 70k.

As illustrated in FIG. 1, the apparatus body 1A includes a frame body 16 that accommodates the rotary body 90. The frame body 16 is a frame body of the apparatus body of the image forming apparatus 1 according to the present embodiment. The frame body 16 is a casing (framework) of the apparatus body 1A implemented by a frame or an exterior member, and has a substantially rectangular parallelepiped shape in the present embodiment.

The frame body 16 includes an opening 16a. More specifically, the frame body 16 includes a side surface 16b that expands in a direction intersecting the horizontal direction. The side surface 16b forms at least a part of an exterior surface on the +X side of the apparatus body 1A. The opening 16a is disposed on the side surface 16b. The side surface 16b is a side surface disposed downstream of a discharge port of the apparatus body 1A in a discharge direction in which the sheet S on which the image is formed is discharged from the discharge port. The user can access the sheet accommodating portion 300 from the side surface 16b of the image forming apparatus 1 to replenish the sheet S or acquire the sheet S discharged from the discharge port. Therefore, the side surface 16b can be referred to as a front surface (front side) of the apparatus body 1A.

The toner cartridges 70y, 70m, 70c, and 70k are attachable to and detachable from the rotary body 90 through the opening 16a. That is, it can be said that the toner cartridge 70k is an example of the first toner cartridge that accommodates the toner to be supplied to the first developing roller (developing roller 51k) and is attachable to and detachable from the rotary (rotary body 90) through the opening 16a of the frame body 16 of the apparatus body 1A. It can be said that the toner cartridge 70m is an example of the second toner cartridge that accommodates the toner to be supplied to the second developing roller (developing roller 51m) and is attachable to and detachable from the rotary (rotary body 90) through the opening 16a of the frame body 16 of the apparatus body 1A.

In the present embodiment, the toner cartridges 70y, 70m, 70c, and 70k are attached to and detached from the rotary body 90 through the opening 16a in a state of being supported by the trays 80y to 80k. In other words, the user can attach and detach the toner cartridges 70y to 70k to and from the rotary body 90 via the trays 80y to 80k.

The opening 16a is disposed on the side surface 16b of the frame body 16. In the present embodiment, the side surface 16b is a surface substantially parallel to the rotation axis 90C of the rotary body 90. Therefore, in a case where the toner cartridge 70 is replaced, the toner cartridge 70 passes through the opening 16a in a direction intersecting (preferably, a direction orthogonal to) the rotation axis 90C.

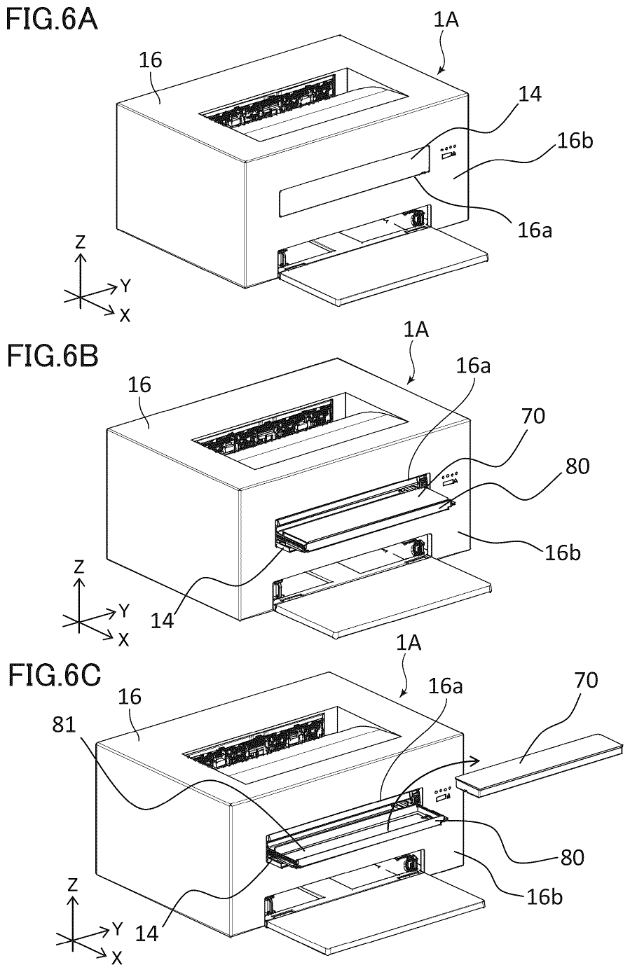

The image forming apparatus 1 includes a door 14 that covers the opening 16a of the frame body 16. The door 14 is an opening/closing member movable between a closed position (see also FIG. 6A) where the opening 16a is covered and an open position (see also FIGS. 6B and 6C) where the opening 16a is exposed.

As described above, in the present embodiment, the toner cartridge 70 is configured to be attachable to and detachable from the rotary body 90 via the tray 80. Therefore, the toner cartridge 70 can be stably attached to and detached from the rotary body 90.

More specifically, the user can replace the toner cartridge 70 by attaching and detaching the toner cartridge 70 to and from the tray 80 configured to be movable with respect to the rotary body 90 (that is, with respect to the apparatus body 1A). In a case of a configuration in which the user directly inserts and removes a toner cartridge into and from an apparatus body to replace the toner cartridge, the user is required to insert the toner cartridge to a predetermined mounting position in the apparatus body. In the present embodiment, the tray 80 is movable such that the toner cartridge 70 moves to the mounting position, in a state of supporting the toner cartridge 70. Therefore, the user can replace the toner cartridge 70 by a simple operation of putting the toner cartridge 70 on the tray 80, and thus, operability is improved.

The toner cartridge 70 has an elongated shape with the Y direction parallel to the rotation axis 90C of the rotary body 90 as a longitudinal direction. That is, a dimension of the toner cartridge 70 in the longitudinal direction is larger than a height and a width of the toner cartridge 70 in a cross section orthogonal to the longitudinal direction. In a case of handling such an elongated toner cartridge 70, since the opening 16a is disposed on the side surface 16b of the frame body 16 substantially parallel to the longitudinal direction (Y direction) of the toner cartridge 70, the toner cartridge 70 can pass through the opening 16a with a short movement distance. For example, the replacement of the toner cartridge 70 is further facilitated as compared with a case where the toner cartridge 70 is inserted and removed through an opening provided on a side surface on any one side (+Y side or −Y side) of the frame body 16 in the longitudinal direction of the toner cartridge 70.

The rotary body 90 can rotate around the rotation axis 90C to take a replacement posture in which removal of any of the toner cartridges 70y to 70k from the rotary body 90 is allowed. A posture in which removal of the toner cartridge 70y is allowed is referred to as a yellow replacement posture. A posture in which removal of the toner cartridge 70m is allowed is referred to as a magenta replacement posture. A posture in which removal of the toner cartridge 70c is allowed is referred to as a cyan replacement posture.

A posture in which removal of the toner cartridge 70k is allowed is referred to as a black replacement posture. The black replacement posture is an example of a first replacement posture in which removal of the first toner cartridge from the rotary body 90 is allowed. The yellow/magenta/cyan replacement posture is an example of a second replacement posture in which removal of the second toner cartridge from the rotary body 90 is allowed. The yellow/magenta/cyan/black replacement posture can also be referred to as first to fourth replacement postures. The numbers are merely used for convenience of description, and can be appropriately changed in principle.

The rotary body 90 rotates clockwise in FIG. 1 around the rotation axis 90C, and can sequentially take the yellow/magenta/cyan/black replacement postures. In the present embodiment, switching between the developing posture and the replacement posture is made by rotating the rotary body 90 clockwise in FIG. 1 around the rotation axis 90C. For example, in FIG. 1, the rotary body 90 takes the black developing posture. When the rotary body 90 rotates clockwise in this state, the posture of the rotary body 90 is switched in the order of the cyan replacement posture, the yellow developing posture, the black replacement posture, the magenta developing posture, the yellow replacement posture, the cyan developing posture, and the magenta replacement posture. When the rotary body 90 rotates clockwise from the magenta replacing posture, the rotary body 90 returns to the black developing posture. That is, the rotary body 90 can rotate clockwise by one rotation (360°) or more.

FIG. 4A illustrates a cross section of the rotary body 90 in a state of taking the developing posture (specifically, the yellow developing posture). FIG. 4B illustrates a cross section of the rotary body 90 in a state of taking the replacement posture (specifically, the black replacement posture).

As illustrated in FIGS. 4A and 4B, four trays 80y to 80k are attached to the rotary body 90. The toner cartridges 70y to 70k are held by the trays 80y to 80k, respectively. In FIGS. 4A and 4B, the trays 80y to 80k are accommodated in the rotary body 90, and such a state can be referred to as a state in which the toner cartridges 70y to 70k are mounted on the developing units 50y, 50m, 50c, and 50k.

As described above, the toner cartridge 70 is movable to the mounting position and the retracted position where the toner cartridge 70 is retracted from the mounting position with respect to the developing frame body 53 of the developing unit 50. That is, the first toner cartridge (toner cartridge 70k) is movable to a first mounting position and a first retracted position with respect to the first accommodating frame (developing frame body 53k). The second toner cartridge (toner cartridge 70m) is movable to a second mounting position and a second retracted position with respect to the second accommodating frame (developing frame body 53m).

In a state in which the toner cartridge 70 is at the mounting position with respect to the developing frame body 53, the discharge opening 71b and the reception opening 53b face each other as illustrated in FIG. 3. In this state, the toner cartridge 70 is configured to supply the toner to the developing side accommodating portion 53a through the reception opening 53b (the opening of the accommodating frame).

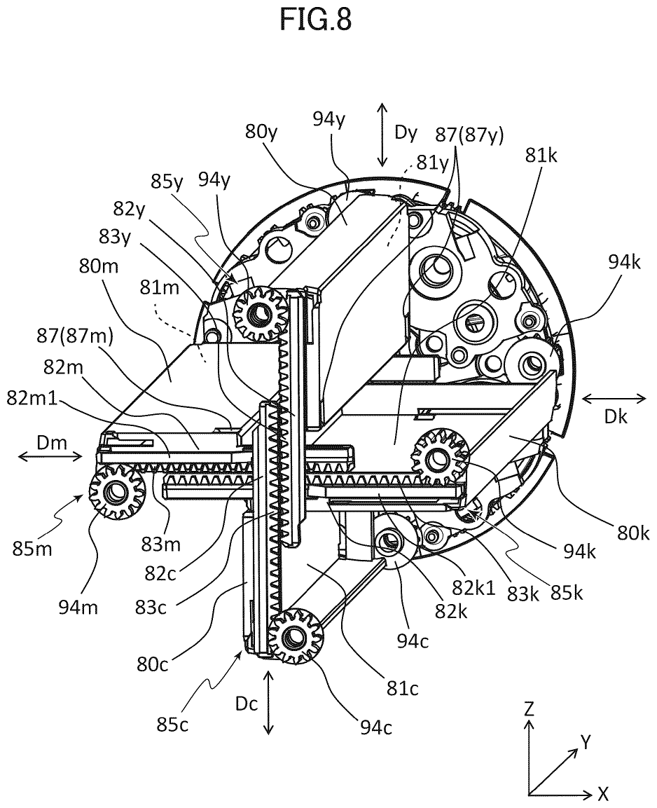

The apparatus body 1A includes a movement device 85 configured to move the toner cartridge 70 from the mounting position to the retracted position with respect to the rotary body 90 (more specifically, with respect to the developing frame body 53 of the developing unit 50). The movement device 85 will be described below with reference to FIG. 8 and the like. In the present embodiment, a plurality of movement devices 85y to 85k corresponding to the plurality of toner cartridges 70y to 70k are disposed in the rotary body 90. The trays 80y to 80k can be regarded as parts of the movement devices 85y to 85k.

In the present embodiment, the toner cartridge 70k housing the black toner is larger in size than the toner cartridges 70y to 70c housing the yellow toner, the magenta toner, and the cyan toner, and can accommodate a larger amount of toner. In other words, it can be said that the first toner cartridge can accommodate a first amount of toner, the second toner cartridge can accommodate a second amount of toner, and the first amount is larger than the second amount.

Specifically, a length of the black toner cartridge 70k in a first radial direction with respect to the rotation axis 90C of the rotary body 90 is larger than a length of the magenta toner cartridge 70m in a second radial direction. Here, the first radial direction is a rotation radius direction of the rotary body 90 (a radial direction of a virtual circle centered on the rotation axis 90C), and is a direction in which the toner cartridge 70k extends with respect to the rotation axis 90C when viewed in the direction of the rotation axis 90C. The second radial direction is a rotation radius direction of the rotary body 90, and is a direction in which the toner cartridge 70m extends with respect to the rotation axis 90C when viewed in the direction of the rotation axis 90C. Similarly, the length of the black toner cartridge 70k in the first radial direction is larger than lengths of the other toner cartridges 70y and 70c in radial directions corresponding to the toner cartridges 70y and 70c.

Therefore, the tray 80k holding the black toner cartridge 70k is larger in size than the trays 80y to 80c holding the other toner cartridges 70y, 70m, and 70c. That is, four toner cartridges 70y to 70k and four trays 80y to 80k having different sizes are disposed in the rotary body 90. In other words, the toner cartridge 70k serving as an example of the first toner cartridge and the toner cartridge 70y serving as an example of the second toner cartridge smaller in size than the first toner cartridge are attachable to and detachable from the rotary body 90. Correspondingly, the tray 80k serving as an example of the first support member that supports the first toner cartridge and the tray 80y serving as an example of the second support member smaller in size than the first support member are provided in the rotary body 90. The toner cartridges 70m and 70c serving as examples of the third toner cartridge and the fourth toner cartridge smaller in size than the first toner cartridge are attachable to and detachable from the rotary body 90. Correspondingly, the trays 80m and 80c serving as examples of the third support member and the fourth support member smaller in size than the first support member are provided in the rotary body 90.

Here, rotational driving of the rotary body 90 will be described with reference to FIG. 5. As illustrated in FIG. 5, disk gears 92L and 92R are formed at both end portions of the rotary body 90. Rotary driving gears 93L and 93R are connected to both end portions of a swing shaft 91 so as to be able to transmit the driving force. Here, the driving force of the motor M1 is transmitted to the rotary driving gear 93R by a drive transmission mechanism. Next, the rotary driving gears 93L and 93R transmit the driving force to the disk gears 92L and 92R, thereby rotationally driving the rotary body 90. The rotary body 90 rotates around the rotation axis 90C clockwise in FIG. 1.

The rotary body 90 is supported so as to be swingable around the swing shaft 91. The rotary body 90 is urged in a counterclockwise direction in FIGS. 4A and 4B around the swing shaft 91 by an urging member (not illustrated). The direction can be referred to as a direction in which each of the developing rollers 51y to 51k approaches the photosensitive drum 2. As a result, each of the developing rollers 51y to 51k comes into contact with the photosensitive drum 2 in a state in which the rotary body 90 takes the developing posture.

Meanwhile, as illustrated in FIG. 5, rotary cams 90eL and 90eR are provided at both end portions of the rotary body 90. When the rotary body 90 rotates clockwise in FIGS. 4A and 4B around the rotation axis 90C, the rotary cams 90eL and 90eR come into contact with a roller 96 (FIGS. 4A and 4B) supported by the frame body 16. Then, the rotary cams 90eL and 90eR move in a clockwise direction in FIGS. 4A and 4B around the swing shaft 91. The direction can be referred to as a direction in which each of the developing rollers 51y to 51k moves away from the photosensitive drum 2. Further, the direction can be referred to as a direction in which the rotary body 90 approaches the opening 16a of the frame body 16 and the door 14.

As a result, when the rotary body 90 rotates and performs switching from the developing posture to the replacement posture, the rotary body 90 swings around the swing shaft 91. In a state in which the rotary body 90 takes the replacement posture, the developing roller 51 is separated from the photosensitive drum 2.

As illustrated in FIG. 4B, in the black replacement posture, the toner cartridge 70k stops at a position facing the opening 16a and the door 14 provided on the side surface 16b of the apparatus body 1A. In this state, when the tray 80k is slid from the mounting position on the developing unit 50k to the outside of the rotary body 90, the user can replace the toner cartridge 70k.

### Toner Cartridge Replacement Operation

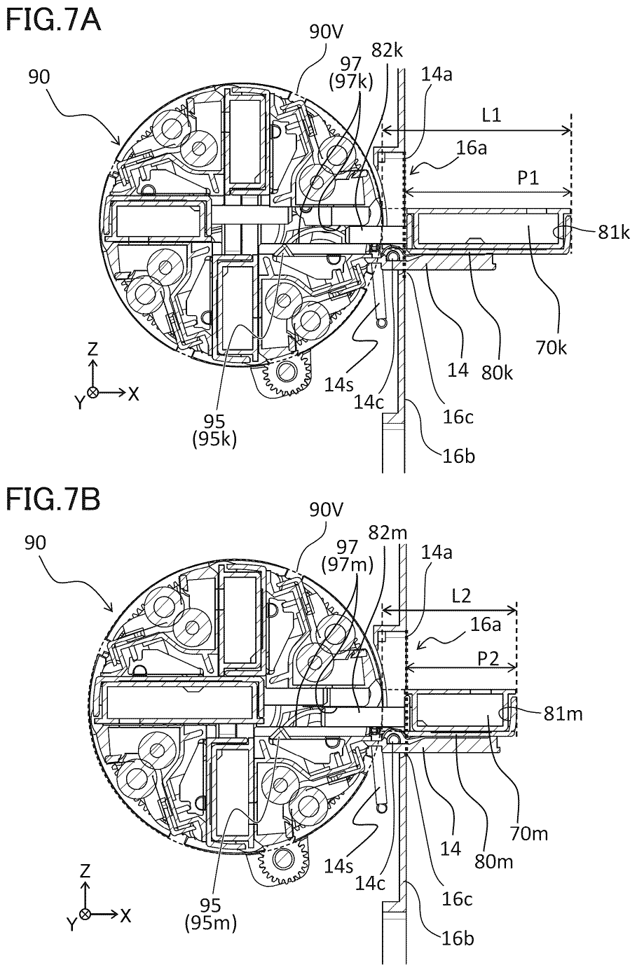

A toner cartridge replacement operation will be described with reference to FIGS. 4A, 6A, 6B, 6C, 7A, and 7B. FIGS. 6A, 6B, and 6C are exterior views of the apparatus body 1A. FIGS. 7A and 7B are cross-sectional views of the periphery of the rotary body 90 at the time of toner cartridge replacement. FIGS. 7A and 7B are cross-sectional views of the apparatus in a virtual plane perpendicular to the rotation axis 90C of the rotary body 90.

FIG. 6A illustrates an exterior of the apparatus body 1A during the image forming operation and in a standby state. The expression “during the image forming operation” refers to a period in which a series of operations is performed, from when the image forming apparatus 1 feeds the sheet S and forms an image on the sheet S to when the sheet S is discharged as a product. The standby state refers to a state in which the image forming operation can be started in a case where the image forming apparatus 1 receives an image forming instruction (print instruction), and is a state of waiting for the image forming instruction from the user. As illustrated in FIG. 6A, the door 14 is in the closed state during the image forming operation and in the standby state.

FIG. 6B illustrates an exterior of the apparatus body 1A at the time of toner cartridge replacement. At the time of toner cartridge replacement, the door 14 is opened, and the tray 80 and the toner cartridge 70 are moved to the outside of the apparatus body 1A.

The toner cartridge 70 is movable to the mounting position and the retracted position where the toner cartridge 70 is retracted from the mounting position with respect to the developing frame body 53 of the developing unit 50. In a state in which the toner cartridge 70 is at the mounting position with respect to the developing frame body 53, the discharge opening 71b and the reception opening 53b face each other as illustrated in FIG. 3. As illustrated in FIGS. 4A and 4B, the rotary body 90 is configured to rotate around the rotation axis 90C and take the developing posture or the replacement posture in a state in which the toner cartridge 70 is at the mounting position.

The toner cartridge replacement operation will be described. First, the user instructs the control unit 30 (FIG. 2) of the apparatus body 1A to perform the toner cartridge replacement operation. The instruction for the toner cartridge replacement operation is made, for example, by input through an operation panel (operation unit) provided in the apparatus body 1A.

When the control unit 30 receives the instruction for the toner cartridge replacement operation, the rotary body 90 rotates to take the replacement posture for the toner cartridge 70 to be replaced (the toner cartridge 70 having no toner) and stops. That is, the control unit 30 rotates the rotary body 90 so as to take the replacement posture for the toner cartridge (the black replacement posture for replacing the black toner cartridge 70k in FIG. 4B) designated in the instruction for the toner cartridge replacement operation. In the replacement posture, the tray 80 that supports the toner cartridge 70 for which replacement has been instructed faces the opening 16a of the frame body 16 of the apparatus body 1A.

For example, the rotary body 90 of FIG. 4A takes the yellow developing posture in which the yellow developing roller 51y faces the photosensitive drum 2. At this time, the black toner cartridge 70k and the tray 80k do not have to face the opening 16a and the door 14. In other words, the toner cartridge 70 and the tray 80 do not have to face the opening 16a and the door 14 in a case where the rotary body 90 is in a replacement posture other than the replacement posture for the corresponding toner cartridge or the developing posture. Therefore, it is sufficient if the opening 16a has a size that allows each toner cartridge 70 to pass individually. When the rotary body 90 rotates clockwise by a predetermined angle in the drawing in the yellow developing posture, the black toner cartridge 70k and the tray 80k face the opening 16a and the door 14 as illustrated in FIG. 4B.

Here, the expression “the tray 80 faces the opening 16a” means that the tray 80 is positioned so as to be movable to the outside of the apparatus body 1A through the opening 16a. That is, in a case where the tray 80 faces the opening 16a, when the tray 80 is moved outward in the rotation radius direction of the rotary body 90 by a movement mechanism described below, the tray 80 and the toner cartridge 70 supported by the tray 80 can protrude to the outside of the apparatus body 1A. In FIG. 4A, none of the trays 80y to 80k faces the opening 16a. In FIG. 4B, only the black tray 80k faces the opening 16a, and the other trays 80y to 80c do not face the opening 16a.

When the rotary body 90 is positioned so as to take the replacement posture, the tray 80 supporting the toner cartridge 70 to be replaced is moved toward the outside of the apparatus body 1A by the motor M2.

As a result, the toner cartridge 70 to be replaced moves from the mounting position to the retracted position with respect to the rotary body 90. As illustrated in FIGS. 6B, 6C, 7A, and 7B, the tray 80 and the toner cartridge 70 to be replaced supported by the tray 80 protrude to the outside of the apparatus body 1A through the opening 16a.

More specifically, the tray 80 is movable to a housing position and a take-out position with respect to the rotary body 90. That is, the first tray is movable to the housing position (first position) and the take-out position (second position) with respect to the rotary body 90. The second tray is movable to the housing position (third position) and the take-out position (fourth position) with respect to the rotary body 90. The housing position is a position where the tray 80 is accommodated in the rotary body 90. The take-out position is a position (removal position or replaceable position) where the tray 80 protrudes to the outside of the rotary body 90 and the toner cartridge 70 can be taken out from the tray 80. Examples of the housing position include a position of each of the trays 80y to 80k in FIGS. 4A and 4B. Examples of the take-out position include positions of the tray 80 in FIGS. 6B and 6C, the tray 80k in FIG. 7A, and the tray 80m in FIG. 7B.

When the tray 80 is at the housing position, the toner cartridge 70 attached to the tray 80 is positioned inside the rotary body 90 and is positioned at the mounting position. When the tray 80 is at the take-out position, the toner cartridge 70 to which the tray 80 is attached is positioned outside the rotary body 90 and is positioned at the retracted position.

Here, as illustrated in FIGS. 7A and 7B, the rotary body 90 has a protrusion 95 for holding the tray 80 at the housing position and holding the toner cartridge 70 at the mounting position. As illustrated in FIG. 8, a recess 87 fitted to the protrusion 95 is provided in the tray 80. Although protrusions 95k and 95m corresponding to the trays 80k and 80m are illustrated in FIGS. 7A and 7B, and recesses 87y and 87m of the trays 80y and 80m are illustrated in FIG. 8, the protrusion 95 and the recess 87 are provided for each of the trays 80y to 80k. The protrusion 95 is preferably urged so as to engage with the recess 87.

The tray 80 is locked to the rotary frame body 90f by fitting the protrusion 95 into the recess 87 of the tray 80. As a result, even when the rotary body 90 rotates, the tray 80 remains at the housing position, and the toner cartridge 70 is prevented from moving from the mounting position. In a case where the tray 80 is moved between the housing position and the take-out position by the movement device described below, the protrusion 95 is moved by the tray 80, so that the protrusion 95 can be removed from the recess 87.

In the present embodiment, the door 14 is rotatably supported with respect to the apparatus body 1A. As illustrated in FIG. 7A, the door 14 is urged by a spring 14s from the open position toward the closed position. The spring 14s is, for example, a tension spring, and urges the door 14 so as to generate a moment in the counterclockwise direction in FIGS. 7A and 7B around a support shaft 14c of the door 14.

When the tray 80 pushes the door 14, the door 14 is opened (a state of FIG. 6B). This state can also be referred to as a state in which the tray 80 is supported by the door 14. At least a part of the tray 80 protruding to the outside of the apparatus body 1A is supported by the door 14, so that the toner cartridge 70 can be more stably supported. In other words, when the first toner cartridge (toner cartridge 70k) is at the first retracted position, the opening/closing member (door 14) at the open position supports the first support member (tray 80k). When the second toner cartridge (toner cartridge 70y, 70m, or 70c) is at the second retracted position, the opening/closing member (door 14) at the open position supports the second support member (tray 80y, 80m, or 80c).

The door 14 is configured to come into contact with a part (for example, a lower edge 16c of the opening 16a) of the frame body 16 of the apparatus body 1A at the open position, and is configured not to rotate downward beyond the open position. When the tray 80 is pulled back from the outside to the inside of the apparatus body 1A, the door 14 returns to the closed position by an urging force of the spring 14s.

The toner cartridge 70 is detachably held by the tray 80. Therefore, as illustrated in FIG. 6C, the user can perform work (replacement work) of removing the toner cartridge 70 from the tray 80 and attaching a new toner cartridge 70. In a case of replacing a plurality of toner cartridges 70, the replacement work can be performed by repeating the above operation.

FIGS. 7A and 7B each illustrate a cross section of the periphery of the rotary body 90 at the time of toner cartridge replacement. FIG. 7A illustrates a state at the time of replacement of the black toner cartridge 70k. FIG. 7B illustrates a state at the time of replacement of the magenta toner cartridge 70m.

The image forming apparatus 1 includes the movement devices 85y, 85m, 85c, and 85k (FIG. 8) that move the toner cartridges 70y, 70m, 70c, and 70k from the mounting positions to the retracted positions, respectively. The “movement device 85” without the subscripts usually indicates any one of the movement devices 85y, 85m, 85c, and 85k. In the present embodiment, it can be said that the movement device 85 includes the tray 80. The movement device 85k including the tray 80k can be said to be an example of a first movement device including the first support member. The movement device 85m including the tray 80m can be said to be an example of a second movement device including the second support member.

Even in a state in which the toner cartridge 70 is at the retracted position, the tray 80 is connected to the rotary body 90 (supported by the rotary body 90). It is preferable that a length of a portion of the toner cartridge 70 that protrudes from the rotary body 90 at the retracted position is large in order to easily perform an operation of removing the toner cartridge 70 from the rotary body 90. Since the toner cartridge 70 is configured to be attachable to and detachable from the rotary body 90 via the tray 80, the toner cartridge 70 can be stably supported by the tray 80 even in a case where the length of the portion of the toner cartridge 70 that protrudes from the rotary body 90 is large.

A movement direction of the toner cartridge 70 when the toner cartridge 70 moves from the mounting position to the retracted position is referred to as a retraction direction. In the present embodiment, the retraction direction of the toner cartridge 70 is a direction intersecting the direction of the rotation axis 90C (Y direction). Therefore, as illustrated in FIGS. 7A and 7B, the retraction direction of the toner cartridge 70 is a direction orthogonal to the direction of the rotation axis 90C (Y direction) when viewed in the direction of the rotation axis 90C (Y direction). In addition, it can be said that the retraction direction of the toner cartridge 70 is a direction toward the outside in the rotation radius direction of the rotary body 90 (a direction away from the rotation axis 90C).

As illustrated in FIGS. 7A and 7B, the user performs the operation of removing the toner cartridge 70 from the rotary body 90, and thus, it is preferable that at least a part of the toner cartridge 70 protrudes from the rotary body 90 at the time of removal of the toner cartridge 70. In the present embodiment, when the toner cartridge 70 is at the retracted position, the entire toner cartridge 70 protrudes from the rotary body 90.

It can be said that a rotation locus of the rotary body 90 coincides with a circumscribed circle of the rotary body 90 around the rotation axis 90C (a virtual circle 90V indicated by a broken line in FIGS. 7A and 7B) when the rotary body 90 rotates around the rotation axis 90C. When the toner cartridge 70 is at the retracted position, it is preferable that a portion corresponding to half or more of the length of the toner cartridge 70 in the retraction direction is outside the rotation locus of the rotary body 90. That is, when viewed in the rotation axis direction of the rotary, in a state in which the toner cartridge is at the retracted position, it is preferable that a portion corresponding to half or more of the total length of the toner cartridge is positioned outside the rotation locus of the rotary in the movement direction of the toner cartridge from the mounting position to the retracted position. This applies to the respective toner cartridges 70 including the toner cartridge 70k serving as an example of the first toner cartridge and the toner cartridge 70m serving as an example of the second toner cartridge. In the present embodiment, as illustrated in FIGS. 7A and 7B, when the toner cartridge 70 is at the retracted position, the entire toner cartridge 70 is outside the rotation locus (virtual circle 90V) of the rotary body 90.

Furthermore, it is preferable that at least a part of the toner cartridge 70 is outside the image forming apparatus 1 (outside the apparatus body 1A) when the toner cartridge 70 is at the retracted position in order to make it easy for the user to grasp the toner cartridge 70. Here, the outside of the apparatus refers to a space outside the image forming apparatus 1 (outside the apparatus body 1A) at the time of the use of the image forming apparatus 1, for example, at the time of performing the image forming operation for the sheet S.

In the present embodiment, the exterior surface of the apparatus body 1A is formed by an exterior surface of the frame body 16. That is, the outside of the apparatus can also be referred to as the outside of the frame body 16. Therefore, a state in which at least a part of the toner cartridge 70 is outside the apparatus can also be referred to as a state in which at least a part of the toner cartridge 70 protrudes from the opening 16a of the frame body 16 of the apparatus body 1A toward the outside of the frame body 16.

In the present embodiment, when the door 14 is at the closed position, the opening 16a of the frame body 16 of the apparatus body 1A is covered with the door 14. A part of the exterior surface of the apparatus body 1A is formed by an exterior surface 14a of the door 14 at the closed position. In this case, the outside of the apparatus refers to the outside of the exterior surface 14a of the door 14 at the closed position. That is, in a case where it is assumed that a position of the exterior surface 14a of the door 14 at the closed position is an exterior position, at least a part of the toner cartridge 70 is positioned outside the apparatus body 1A beyond the exterior position when the toner cartridge 70 is at the retracted position.

In other words, at least a part of the toner cartridge 70 is positioned in a space outside the apparatus body 1A if the door 14 is at the closed position. At least a part of the toner cartridge 70 is positioned downstream of the exterior position in the retraction direction of the toner cartridge 70.

In addition, when the side surface 16b on which the opening 16a is provided is defined as the front surface of the apparatus body 1A and the toner cartridge 70 is at the retracted position, at least a part of the toner cartridge 70 can be said to protrude toward a front surface side from the exterior surface on the front surface side of the apparatus body 1A. In this case, the user can easily perform work of replacing the toner cartridge 70 by accessing the toner cartridge 70 from the front surface side of the image forming apparatus.

When the toner cartridge 70 is at the retracted position, it is preferable that a portion corresponding to half or more of the length of the toner cartridge 70 in the retraction direction is outside the apparatus. That is, when viewed in the rotation axis direction of the rotary, in a state in which the toner cartridge is at the retracted position, it is preferable that a portion corresponding to half or more of the total length of the toner cartridge is positioned outside the frame body of the apparatus body in the movement direction of the toner cartridge from the mounting position to the retracted position. This applies to the respective toner cartridges 70 including the toner cartridge 70k serving as an example of the first toner cartridge and the toner cartridge 70m serving as an example of the second toner cartridge. Further, when the toner cartridge 70 is at the retracted position, it is more preferable that the entire toner cartridge 70 is outside the apparatus. In the present embodiment, the exterior surface 14a of the door 14 and the side surface 16b form the exterior surface on the front surface side of the apparatus body 1A, but the configuration of the door 14 is not limited thereto. For example, a size of the door 14 may be set to a size that covers the entire side surface 16b. In this case, the exterior surface 14a of the door 14 forms the exterior surface on the front surface side of the apparatus body 1A.

The tray 80 includes a cartridge holding portion 81 (see FIGS. 3 and 6C) that holds the toner cartridge 70. The cartridge holding portion 81 is a mounting target portion on which the toner cartridge 70 is mounted. When the tray 80 is at the take-out position, it is preferable that the entire cartridge holding portion 81 is outside the rotation locus of the rotary body 90 in the retraction direction. When the tray 80 is at the take-out position, it is preferable that a portion corresponding to half or more of a length of the cartridge holding portion 81 is outside the apparatus in the retraction direction.

Here, as described above, the toner cartridge 70k and the tray 80k are larger in size than the other toner cartridges 70y to 70c and the trays 80y to 80c. Therefore, as illustrated in FIGS. 7A and 7B, in the present embodiment, a movement amount of the tray 80 at the time of toner cartridge replacement is changed according to the size of the toner cartridge 70.

Specifically, as illustrated in FIG. 7A, a movement distance when the tray 80k (first support member) moves from the housing position (first housing position) to the take-out position (first take-out position) is L1. A movement distance when the tray 80m (second support member) moves from the housing position to the take-out position (third take-out position) is L2. FIG. 7B illustrates a state in which the toner cartridge 70m and the tray 80m have moved, and movement distances when the trays 80y and 80c move from the housing positions to the take-out positions are also L2. At this time, L1 is longer than L2. In other words, it can be said that the movement distance of the first support member when the first toner cartridge moves from the first mounting position to the first retracted position is longer than the movement distance of the second support member when the second toner cartridge moves from the second mounting position to the second retracted position.

As illustrated in FIG. 7A, in a state in which the tray 80k is at the take-out position and the toner cartridge 70k is at the retracted position, the toner cartridge 70k protrudes to the outside of the apparatus from the exterior surface of the apparatus body 1A by a distance P1. In the present embodiment, the tray 80k also protrudes to the outside of the apparatus from the exterior surface of the apparatus body 1A by the distance P1.

As illustrated in FIG. 7B, in a state in which the tray 80m is at the take-out position and the toner cartridge 70m is at the retracted position, the toner cartridge 70m protrudes to the outside of the apparatus from the exterior surface of the apparatus body 1A by a distance P2. In the present embodiment, the tray 80m also protrudes to the outside of the apparatus from the exterior surface of the apparatus body 1A by the distance P2. The toner cartridges 70y and 70c also protrude to the outside of the apparatus from the exterior surface of the apparatus body 1A by the distance P2.

The distance P1 is longer than the distance P2. That is, a length by which the first toner cartridge at the first retracted position protrudes from the opening 16a of the apparatus body 1A is defined as a first length (P1), and a length by which the second toner cartridge at the second retracted position protrudes from the opening 16a is defined as a second length (P2). In this case, it can be said that the first length is larger than the second length.

In the toner cartridges 70y to 70c that are smaller in size than the toner cartridge 70k, it is preferable in terms of strength that the distance P2 by which the toner cartridges 70y to 70c protrude to the outside of the apparatus at the retracted position is shorter than the distance P1 by which the toner cartridge 70k protrudes to the outside of the apparatus at the retracted position. This is due to the following reasons. When the toner cartridge 70 is positioned at the retracted position, at least a part of the toner cartridge 70 protrudes to the outside of the rotation locus of the rotary body 90 or the outside of the apparatus body 1A. At this time, the tray 80 supports a weight of the toner cartridge 70 in a state of being cantilevered by the rotary body 90. Therefore, in a case where the distance P2 by which the toner cartridges 70y to 70c protrude to the outside of the apparatus at the retracted position is short, it is possible to reduce a load applied to a guide portion 97 of the rotary body 90 that supports the trays 80y to 80c or the trays 80y to 80k. In addition, since the toner cartridges 70y to 70c are smaller in size than the toner cartridge 70k, it is possible to maintain workability in cartridge replacement on the trays 80y to 80c even through the distance P2 is shorter than the distance P1.

### Tray Arrangement in Rotary

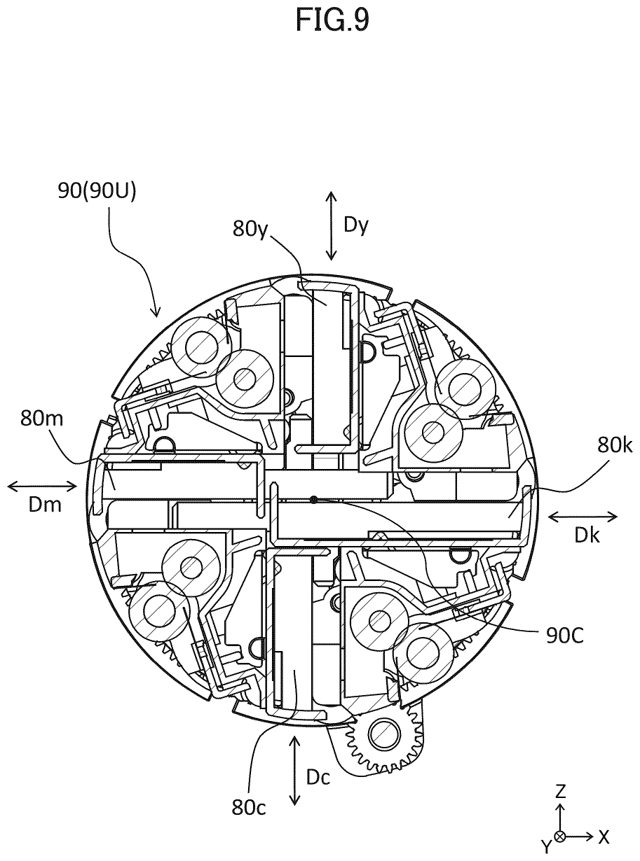

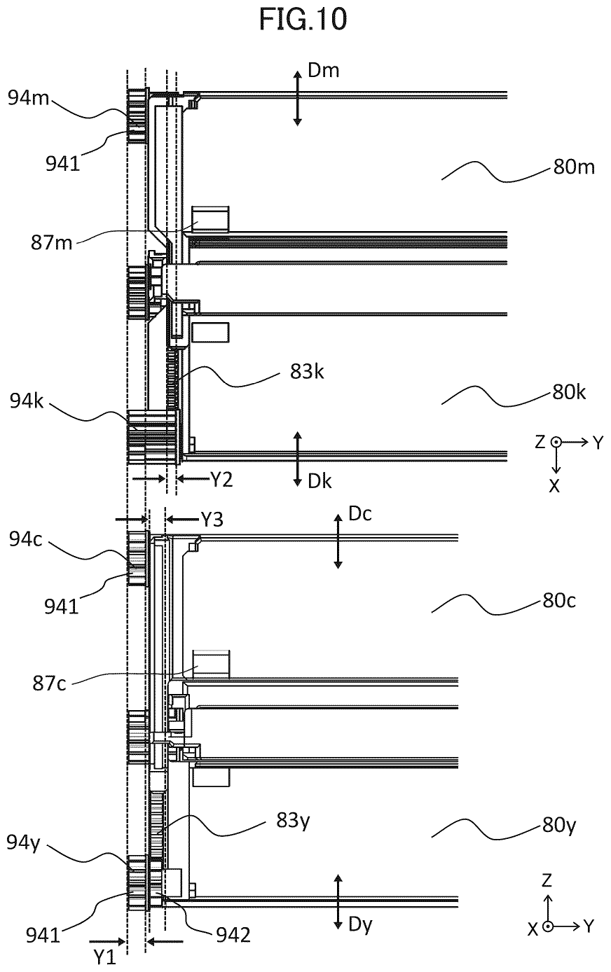

Arrangement of the trays 80y to 80k in the rotary body 90 will be described with reference to FIGS. 8, 9, and 10. FIG. 8 is a perspective view illustrating the arrangement of the trays 80y to 80k in the rotary body 90. FIG. 9 is a cross-sectional view illustrating the arrangement of the trays 80y to 80k in the rotary body 90. FIG. 10 is a view illustrating member arrangement on one end sides of the trays 80y to 80k in the Y direction. FIG. 9 illustrates a cross section of the rotary body 90 in a virtual plane perpendicular to the rotation axis 90C of the rotary body 90. The upper half portion of FIG. 10 is a view of the rotary body 90 and the trays 80m and 80k of FIG. 8 when viewed from the upper right side (+Z side) of FIG. 8, and the lower half portion of FIG. 10 is a view of the rotary body 90 and the trays 80c and 80y of FIG. 8 when viewed from the left side (−X side) of FIG. 8.

As illustrated in FIG. 8, cartridge holding portions 81y to 81k and guided portions 82y to 82k are provided on the trays 80y to 80k, respectively.

The toner cartridges 70y to 70k are mounted on the cartridge holding portions 81y to 81k, respectively. Each of the cartridge holding portions 81y to 81k accommodates at least a part of each of the toner cartridges 70y to 70k mounted thereon.

The guided portions 82y to 82k are provided at both end portions of the trays 80y to 80k sandwiching the cartridge holding portions 81y to 81k in the Y direction. Each of the guided portions 82y to 82k is a member elongated in a direction orthogonal to the rotation axis of the rotary body 90.

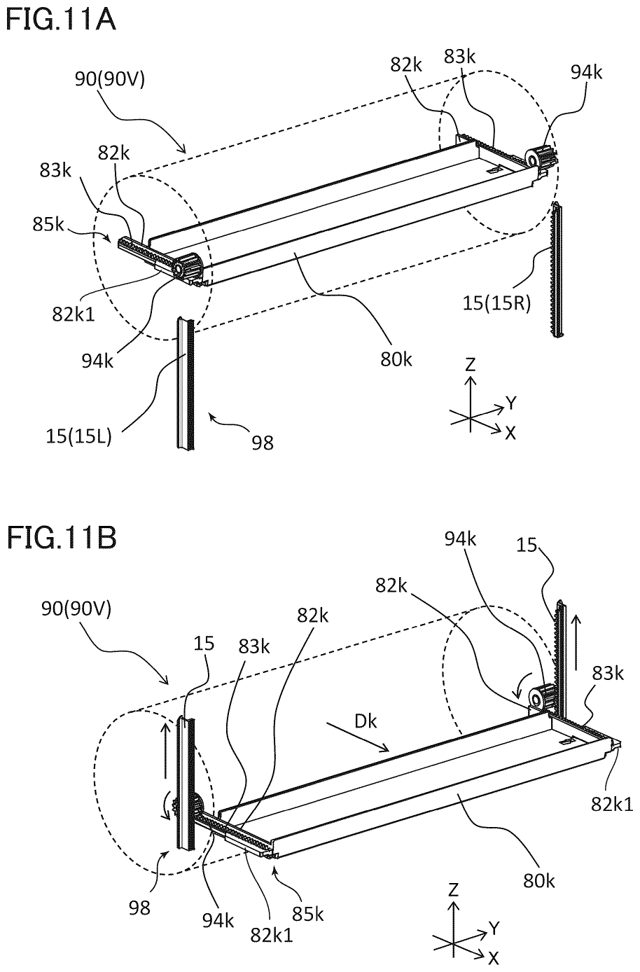

In the present embodiment, a reinforcement rib 82k1 is formed at a part of the guided portion 82k in a movement direction Dk of the tray 80k, and a reinforcement rib 82m1 is formed at a part of the guided portion 82m in a movement direction Dm of the tray 80m (see also FIGS. 11A and 11B). The reinforcement ribs 82k1 and 82m1 have rib shapes (ridge shapes) protruding outward in the Y direction from the guided portions 82k and 82m provided at both end portions of the trays 80k and 80m in the Y direction and elongated in the movement directions Dk and Dm of the trays 80k and 80m. A stiffness of the guided portions 82k and 82m is improved by the reinforcement ribs 82k1 and 82m1.

In the present embodiment, lengths of the reinforcement ribs 82m1 and 82k1 are limited to avoid the guided portions 82y and 82c. However, in a case where interference with the guided portions 82y and 82c does not occur, the reinforcement ribs 82m1 and 82k1 may be provided over the entire lengths of the guided portions 82m and 82k. The reinforcement ribs may be added to the guided portions 82y and 82c. In a case where the guided portions 82m and 82k have sufficient stiffness, the reinforcement ribs 82m1 and 82k1 do not have to be provided.

Rack portions 83y to 83k (rack gears) are formed on the guided portions 82y to 82k. Pinion gears 94y to 94k are rotatably held in the rotary body 90. The pinion gears 94y to 94k mesh with the rack portions 83y to 83k so as to be able to transmit the driving force.

One or more rack portions 83y are provided on the tray 80y. One or more pinion gears 94y corresponding to one or more rack portions 83y are provided in the rotary body 90. Similarly, one or more rack portions 83m, one or more rack portions 83c, and one or more rack portions 83k are provided on the tray 80m, the tray 80c, and the tray 80k, respectively. One or more pinion gears 94m, one or more pinion gears 94c, and one or more pinion gears 94k respectively corresponding to one or more rack portions 83m, one or more rack portions 83c, and one or more rack portions 83k are provided in the rotary body 90.

The rack portions 83y to 83k and the pinion gears 94y to 94k are parts of the movement devices 85y to 85k configured to move the toner cartridges 70y to 70k from the mounting positions to the retracted positions. Further, the rack portions 83y to 83k and the pinion gears 94y to 94k can be regarded as parts of driven devices driven by the driving device 98 of the apparatus body 1A. The pinion gears 94y to 94k can be referred to as rotary members (rotating members) that rotate to move the trays 80y to 80k with respect to the rotary body 90.

The movement devices 85y to 85k are driven by the driving device 98 of the apparatus body 1A. The pinion gears 94y to 94k and the rack portions 83y to 83k function as driven portions for the movement devices 85y to 85k of the rotary body 90 to receive the driving force from the driving device 98 of the apparatus body 1A. The pinion gear 94k and the rack portion 83k are examples of a first pinion gear and a first rack gear forming at least a part of a first driven portion included in the first movement device. The pinion gear 94m and the rack portion 83m are examples of a second pinion gear and a second rack gear forming at least a part of a second driven portion included in the second movement device.

The rotary body 90 includes the guide portion 97 (see FIGS. 7A and 7B) that engages with each of the guided portions 82y to 82k. FIG. 7A illustrates the guide portion 97 (97k) that engages with the guided portion 82k of the tray 80k, and FIG. 7B illustrates the guide portion 97 (97m) that engages with the guided portion 82m of the tray 80m. Similar guide portions that engage with the guided portions 82y and 82c of the trays 80y and 80c are provided in the rotary body 90. In FIGS. 7A and 7B, the guide portion 97 provided on one side (+Y side) of the rotary body 90 in the Y direction is illustrated, but the same guide portion 97 is also provided on the other side (−Y side) of the rotary body 90 in the Y direction.

When the tray 80 moves between the housing position and the take-out position, the guide portion 97 maintains a state of engaging with the guided portion 82 in at least a part of a movement range, and guides the movement direction of the tray 80. In the present embodiment, the guide portion 97 maintains a state of engaging with the guided portion 82k in the entire movement range of the tray 80k between the housing position and the take-out position. In addition, in the present embodiment, the guide portion 97 maintains a state of engaging with the guided portion 82m in the entire movement range of the tray 80m between the housing position and the take-out position.

As illustrated in FIGS. 8 and 9, the four trays 80y to 80k are arranged in the rotary body 90 so as to overlap each other as specifically described below.

When the pinion gears 94y to 94k rotate, the rack portions 83y to 83k and the trays 80y to 80k move with respect to the rotary body 90. As illustrated in FIG. 9, the four trays 80y to 80k are arranged such that the movement directions of the four trays 80y to 80k with respect to the rotary body 90 are orientated at 90 degrees to one another. Therefore, the tray 80y and the tray 80c, and the tray 80m and the tray 80k are slidably held in substantially the same direction (parallel direction). The movement direction of each of the trays 80y to 80k at the time of sliding is regulated by the engagement between the guided portions 82y to 82k and the guide portion 97 described above.

The trays 80y to 80k move to the outside of the apparatus through the opening 16a. When each of the trays 80y to 80k moves to the outside of the apparatus through the opening 16a, the movement directions of the trays are substantially the same direction (parallel).

As illustrated in FIG. 9, a range in which the tray 80k is disposed overlaps a range in which the tray 80y is disposed and a range in which the tray 80c is disposed in the movement direction Dk of the tray 80k. The range in which the tray 80k is disposed overlaps the rotation axis 90C of the rotary body 90 in the movement direction Dk of the tray 80k. That is, it can be said that the toner cartridge 70k held by the cartridge holding portion 81k of the tray 80k overlaps the rotation axis 90C of the rotary body 90 (FIG. 4B).

On the other hand, a range in which the tray 80m is disposed is shifted so as not to overlap the range in which the tray 80y is disposed and the range in which the tray 80c is disposed in the movement direction Dm of the tray 80m. Further, the range in which the tray 80y is disposed is shifted so as not to overlap the range in which the tray 80m is disposed and the range in which the tray 80k is disposed in a movement direction Dy of the tray 80y. Similarly, the range in which the tray 80c is disposed is shifted so as not to overlap the range in which the tray 80m is disposed and the range in which the tray 80k is disposed in a movement direction Dc of the tray 80c.

A positional relationship between the trays 80 can also be expressed as follows. The tray 80y and the tray 80k overlap each other, but the tray 80y and the tray 80m do not overlap each other when viewed in the movement direction Dy of the tray 80y. The tray 80m and the tray 80k overlap each other, but the tray 80m and the trays 80y and 80c do not overlap each other when viewed in the movement direction Dm of the tray 80m. The tray 80c and the tray 80k overlap each other, but the tray 80c and the tray 80m do not overlap each other when viewed in the movement direction Dc of the tray 80c.

Here, the fact that two elements (members, components, units, or the like) overlap each other when viewed in a specific direction means that a projection region of one element and a projection region of the other element at least partially overlap each other when each element is vertically projected on a virtual plane perpendicular to the specific direction.

As illustrated in FIGS. 8 and 10, a range in which the rack portion 83m and the guided portion 82m are disposed and a range in which the rack portion 83k and the guided portion 82k are disposed at least partially overlap each other in the direction of the rotation axis 90C (Y direction). That is, in the present embodiment, it can be said that a range in which the first rack gear (rack portion 83k) is disposed and a range in which the second rack gear (rack portion 83m) is disposed at least partially overlap each other in the rotation axis direction (Y direction) of the rotary. Therefore, the rack portions 83m and 83k and the guided portions 82m and 82k can be arranged in a space-saving manner in the Y direction as compared with arrangement in which the rack portion 83m and the guided portion 82m do not overlap the rack portion 83k and the guided portion 82k.

A range in which the rack portion 83y and the guided portion 82y are disposed and a range in which the rack portion 83c and the guided portion 82c are disposed at least partially overlap each other in the direction of the rotation axis 90C (Y direction). That is, in the present embodiment, a range in which a third rack gear (rack portion 83y) is disposed and a range in which a fourth rack gear (rack portion 83c) is disposed at least partially overlap each other in the rotation axis direction (Y direction) of the rotary. Therefore, the rack portions 83y and 83c and the guided portions 82y and 82c can be arranged in a space-saving manner in the Y direction as compared with arrangement in which the rack portion 83y and the guided portion 82y do not overlap the rack portion 83c and the guided portion 82c.

Here, a meshing position between the rack portion (rack gear) 83 and the pinion gear 94 will be described with reference to FIG. 10. The upper half portion of FIG. 10 illustrates a meshing position between the rack portion 83k and the pinion gear 94k. The lower half portion of FIG. 10 illustrates a meshing position between the rack portion 83y and the pinion gear 94y.

The driving force transmitted from the motor M2 (FIG. 2) serving as the driving source by the transmission device described below is transmitted to the pinion gears 94y to 94k in a region Y1 in the drawing in the direction (Y direction) of the rotation axis 90C of the rotary body 90. The pinion gear 94k meshes with the rack portion 83k so as to be able to transmit the driving force in a region Y2 in the drawing in the Y direction. The pinion gear 94y meshes with the rack portion 83y so as to be able to transmit the driving force in a region Y3 in the drawing in the Y direction. Similarly to the rack portion 83k, the rack portion 83m meshes with the pinion gear 94m (FIG. 8) so as to be able to transmit the driving force in the region Y2. Similarly to the rack portion 83y, the rack portion 83c meshes with the pinion gear 94c (FIG. 8) so as to be able to transmit the driving force in the region Y3.

Here, the region Y2 and the region Y3 are at different positions in the Y direction (shifted in the Y direction). The region Y1 is positioned at a position different from both the region Y2 and the region Y3 in the Y direction. That is, the region Y1 is shifted in the Y direction with respect to the region Y2 and the region Y3.

Further, in a state in which the toner cartridges 70y and 70c are at the mounting positions, the range in which the rack portion 83y is disposed and the range in which the rack portion 83c is disposed at least partially overlap each other in the movement direction of the rack portion 83y (the movement direction Dy of the tray 80y). In the present embodiment, since the movement directions Dy and Dc of the trays 80y and 80c are substantially the same direction (parallel), the range in which the rack portion 83y is disposed and the range in which the rack portion 83c is disposed at least partially overlap each other also in the movement direction Dc of the tray 80c. Therefore, in a state in which the toner cartridges 70y and 70c are at the mounting positions, a tooth surface of the rack portion 83y and a tooth surface of the rack portion 83c face each other in a direction (a left-right direction in FIG. 8) orthogonal to the movement directions Dy and Dc of the rack portions 83y and 83c.

Further, in a state in which the toner cartridges 70m and 70k are at the mounting positions, the range in which the rack portion 83m is disposed and the range in which the rack portion 83k is disposed at least partially overlap each other in the movement direction of the rack portion 83m (the movement direction Dm of the tray 80m). In the present embodiment, since the movement directions Dm and Dk of the trays 80m and 80k are substantially the same direction (parallel), the range in which the rack portion 83m is disposed and the range in which the rack portion 83k is disposed at least partially overlap each other also in the movement direction Dk of the tray 80k. Therefore, in a state in which the toner cartridges 70m and 70k are at the mounting positions, a tooth surface of the rack portion 83m and a tooth surface of the rack portion 83k face each other in a direction (an up-down direction in FIG. 8) orthogonal to the movement directions Dm and Dk of the rack portions 83m and 83k.

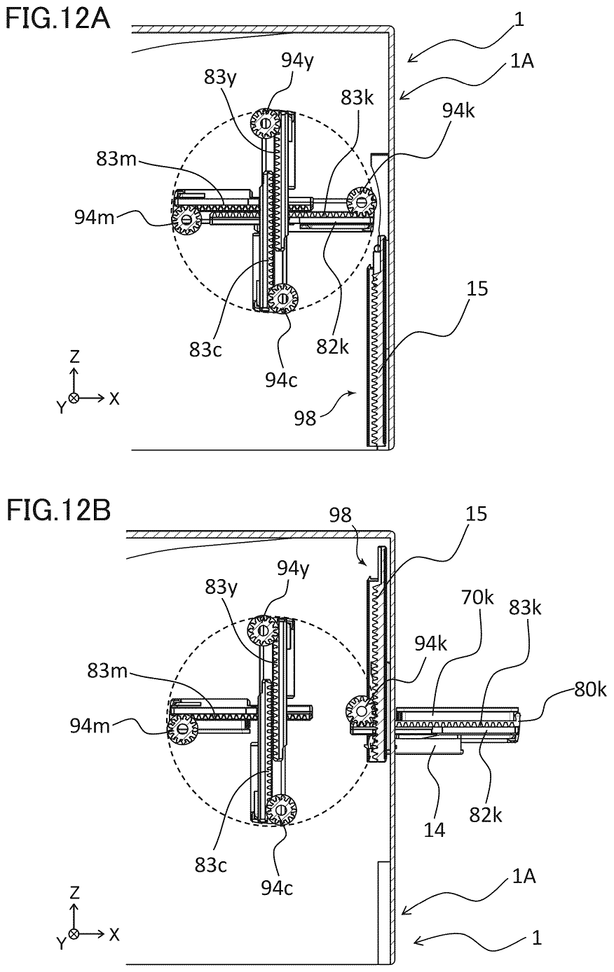

As also illustrated in FIG. 12A described below, the rack portion 83y overlaps the rack portion 83m and the rack portion 83k when viewed in the direction of the rotation axis 90C (Y direction). The rack portion 83m overlaps the rack portion 83y and the rack portion 83c when viewed in the direction of the rotation axis 90C (Y direction). The rack portion 83c overlaps the rack portion 83m and the rack portion 83k when viewed in the direction of the rotation axis 90C (Y direction). The rack portion 83k overlaps the rack portion 83y and the rack portion 83c when viewed in the direction of the rotation axis 90C (Y direction). In other words, it can be said that the range in which the first rack gear (rack portion 83k) is disposed and the range in which the second rack gear (rack portion 83y) is disposed do not overlap each other in the rotation axis direction (Y direction) of the rotary. Further, it can be said that the first rack gear (rack portion 83k) and the second rack gear (rack portion 83y) overlap each other in a state in which the first toner cartridge 70k is at the first mounting position and the second toner cartridge 70y is at the second mounting position when viewed in the rotation axis direction (Y direction) of the rotary.

As described above, since positions where the rack portions 83k and 83m are disposed are different from positions where the rack portions 83y and 83c are disposed in the Y direction, the rack portions 83y and 83c and the rack portions 83m and 83k can be arranged so as to overlap each other when viewed in the Y direction.

As a result, space saving in the arrangement of the four trays in the rotary body 90 can be achieved, and size reduction of the rotary body 90 in the rotation radius direction can be achieved. That is, when the rack portions 83 are arranged so as not to overlap each other when viewed in the Y direction in a state in which the movement distance of each of the trays 80y to 80k is equal to that in the present embodiment, an area required for the arrangement of the four rack portions when viewed in the Y direction is increased. As a plurality of rack portions 83 are arranged such that the positions are shifted in the Y direction, and the rack portions 83 overlap each other when viewed in the Y direction, an arrangement area for the rack portions 83 when viewed in the Y direction can be reduced as compared with such a configuration.

Further, in the present embodiment, the four rack portions 83y to 83k are arranged in two pairs with positions shifted in the Y direction. That is, it can be said that the range in which the first rack gear is disposed and the range in which the second rack gear is disposed overlap each other, and the range in which the third rack gear is disposed and the range in which the fourth rack gear is disposed overlap each other in the rotation axis direction (Y direction) of the rotary. In addition, it can be said that the ranges in which the first rack gear and the second rack gear are disposed and the ranges in which the third rack gear and the fourth rack gear are disposed are arranged so as not to overlap each other in the Y direction. As a result, it is possible to reduce the size of the rotary body 90 in the Y direction as compared with a case where the positions of the four rack portions 83y to 83k are shifted in the Y direction.

### Tray Movement Configuration

A configuration related to the movement of the trays 80y to 80k disposed in the rotary body 90 will be described with reference to FIGS. 11A, 11B, 12A, and 12B. FIGS. 11A and 11B are perspective views illustrating the configuration related to the movement of the tray 80k. FIGS. 12A and 12B are cross-sectional views illustrating the configuration related to the movement of the tray 80k.

In the present embodiment, in each of the trays 80y to 80k, the driving force of the motor M2 is transmitted to the pinion gears 94y to 94k by the drive racks 15L and 15R serving as the transmission devices to drive the pinion gears 94y to 94k. Here, a configuration of moving the tray 80k with respect to the rotary body 90 will be described, and a configuration of moving the trays 80y to 80c with respect to the rotary body 90 is substantially similar to the configuration of moving the tray 80k, and thus a description thereof will be omitted.

FIG. 11A illustrates a state in which the tray 80k is inside the rotary body 90 (that is, the toner cartridge 70k is mounted on the developing unit 50k). That is, FIG. 11A illustrates a state in which the tray 80k is at the housing position, which corresponds to a state in which the toner cartridge 70k is at the mounting position with respect to the developing frame body 53k (FIG. 4A). FIG. 11B illustrates a state in which the tray 80k is slid to the outside of the rotary body 90. That is, FIG. 11B illustrates a state in which the tray 80k is at the take-out position, which corresponds to a state in which the toner cartridge 70k is at the retracted position with respect to the developing frame body 53k (FIG. 4A).

The apparatus body 1A according to the present embodiment includes the drive racks 15L and 15R serving as the driving gears for driving the pinion gears 94. Each drive rack 15 is driven by the motor M2 via the transmission unit 15t. As illustrated in FIG. 11A, in a state in which the tray 80k is inside the rotary body 90 (that is, a state in which the toner cartridge 70k is mounted on the developing unit 50k), the drive racks 15L and 15R are at disengaged positions away from the pinion gears 94k. The drive racks 15L and 15R move from the disengaged positions and engage with the pinion gears 94k such that the tray 80k moves from the housing position to the take-out position and the toner cartridge 70k moves from the mounting position to the retracted position.

As described above, two rack portions 83k are formed at both end portions of the tray 80k in the Y direction. Two pinion gears 94k and two drive racks 15L and 15R are disposed at positions corresponding to the rack portions 83k at both end portions, respectively. That is, the apparatus body 1A according to the present embodiment includes the drive racks 15L and 15R as a first driving gear and a second driving gear. It can be said that the drive rack 15L is an example of the first driving gear, and the drive rack 15R is an example of the second driving gear.

However, the numbers are merely used for convenience of description, and can be appropriately changed in principle. In a case where it is not necessary to distinguish between the drive racks 15L and 15R, the drive racks 15L and 15R are referred to as a “drive rack 15”.

The rack portions 83 according to the present embodiment are configured as a rack gear pair, and the pinion gears 94 according to the present embodiment are configured as a pinion gear pair. In the present embodiment, the rack gear pair and the pinion gear pair are disposed on one end side and the other end side of the support member (tray 80) in the Y direction, and may also be disposed at other positions. It can be said that the rack portions 83k and the pinion gears 94k of the movement device 85k corresponding to the tray 80k are examples of a first rack gear pair and a first pinion gear pair, respectively.

The rack portions 83y to 83c and the pinion gears 94y to 94c of the movement devices 85y to 85c corresponding to the other trays 80y to 80c can be said to be examples of a second rack gear pair and a second pinion gear pair, respectively.

One of the rack gear pair meshes with one of the pinion gear pair, and the other of the rack gear pair meshes with the other of the pinion gear pair. At least one of the pinion gear pair is driven by the drive rack 15L serving as a first drive rack. In the present embodiment, both of the pinion gear pair are simultaneously driven by the drive racks 15L and 15R serving as the first drive rack and a second drive rack. As a result, the rotation of the tray 80 is less likely to occur, and the toner cartridge 70 can be stably moved. The tray 80 may include one rack portion 83, and may be configured to be moved by one drive rack 15 via one pinion gear 94.

The tray 80k is held so as to be slidable in a direction (that is, the movement direction Dk) parallel to the guided portion 82k with respect to the rotary body 90. The drive rack 15 is held so as to be slidable in a direction intersecting the movement direction Dk of the tray 80k with respect to the apparatus body 1A. The drive rack 15 is configured to be slid (reciprocate) in a first direction (vertically upward in the present embodiment) and a second direction (vertically downward in the present embodiment) opposite to the first direction with respect to apparatus body 1A. That is, a movement direction of the drive rack 15 according to the present embodiment is a direction (preferably, a direction orthogonal to) intersecting both the movement direction Dk of the tray 80k and the direction (Y direction) of the rotation axis 90C of the rotary body 90.

A tray movement operation of sliding the tray 80k between the housing position and the take-out position will be described with reference to FIGS. 11A and 11B. The tray movement operation for the tray 80k is performed by the motor M2 (FIG. 2), the transmission unit 15t, the drive rack 15, the pinion gear 94k, and the rack portion 83k.

First, the tray movement operation (tray pull-out operation) when removing the toner cartridge 70k from the rotary body 90 will be described. Before the tray pull-out operation is started, the drive rack 15 is positioned below a position where the drive rack 15 meshes with the pinion gear 94k (FIG. 11A). Further, as described above, in the replacement operation for the toner cartridge 70k, the rotary body 90 takes the replacement posture for the toner cartridge 70k (FIG. 4B).

When the tray pull-out operation is started, the drive rack 15 is slid upward in the apparatus body 1A by the driving force of the motor M2. In a process in which the drive rack 15 moves, the drive rack 15 meshes with the pinion gear 94k, and the pinion gear 94k is rotationally driven.

As illustrated in FIG. 11B, the pinion gear 94k is rotationally driven in an arrow direction in the drawing, so that the driving force is input to the rack portion 83k meshing with the pinion gear 94k. As a result, the tray 80k is pushed out of the apparatus and moves from the housing position to the take-out position with respect to the rotary body 90. The movement direction of the tray 80k at this time is guided to the predetermined movement direction Dk by the engagement between the guided portion 82k and the guide portion 97k (FIG. 7A) of the rotary body 90. As a result of the movement of the tray 80k from the housing position to the take-out position, the toner cartridge 70k is moved from the mounting position to the retracted position with respect to the developing unit 50k.

In a state in which the tray 80k is positioned at the take-out position and the toner cartridge 70k is positioned at the retracted position, the user can attach and detach the toner cartridge 70k to and from the tray 80k.

The tray movement operation (tray pull-in operation or tray insertion operation) when attaching the toner cartridge 70 to the rotary body 90 is performed in a reverse process to the tray pull-out operation. Before the tray pull-in operation is started, the drive rack 15 is positioned above the position where the drive rack 15 meshes with the pinion gear 94k. For example, when the user operates a predetermined operation unit, the tray pull-in operation is started. When the tray pull-in operation is started, the drive rack 15 is slid downward in the apparatus body 1A by the driving force of the motor M2. Here, a rotation direction of the motor M2 in the tray pull-in operation is a direction opposite to that in the tray pull-out operation. In a process in which the drive rack 15 moves, the drive rack 15 meshes with the pinion gear 94k, and the pinion gear 94k is rotationally driven.

When the pinion gear 94k is rotationally driven in a direction opposite to the arrow in FIG. 11B, the driving force is input to the rack portion 83k meshing with the pinion gear 94k. As a result, the tray 80k is pushed into the apparatus and moves from the take-out position to the housing position with respect to the rotary body 90.

The movement direction of the tray 80k is guided to the movement direction Dk (the direction opposite to the arrow in FIG. 11B) by the engagement between the guided portion 82k and the guide portion 97k (FIG. 7A) of the rotary body 90. As a result of the movement of the tray 80k from the take-out position to the housing position, the toner cartridge 70k is moved from the retracted position to the mounting position with respect to the developing unit 50k.

Although the movement of the black tray 80k and the toner cartridge 70k has been described above, the other trays 80y to 80c and the toner cartridges 70y to 70c are also moved by a similar mechanism. That is, in the replacement posture for each toner cartridge, the drive rack 15 transmits the driving force to the pinion gears 94y to 94c.

The motor M2 provided in the apparatus body 1A and the transmission device including the drive rack 15 (15L and 15R) and the transmission unit 15t form the driving device 98 for driving the movement device 85 provided in the rotary body 90.

As described above, in the present embodiment, a plurality of movement devices 85y to 85k corresponding to the plurality of toner cartridges 70y to 70k are disposed in the rotary body 90. The driving device 98 of the apparatus body 1A is a common driving device that drives the plurality of movement devices 85y to 85k (a plurality of driven devices) of the rotary body 90.

In the present embodiment, a driving target of the driving device 98 is switched by the rotation of the rotary body 90. In other words, the driving device according to the present embodiment includes the drive rack 15 serving as a transmission member that transmits the driving force of the driving source. The driving device can be in a state in which the transmission member engages with the first driven portion (pinion gear 94k) so as to be able to transmit the driving force and a state in which the transmission member engages with the second driven portion (pinion gear 94m) so as to be able to transmit the driving force. Further, the driving device can be in a state in which the transmission member is separated from the first driven portion and the second driven portion.

As described above, the pinion gears 94y to 94k are held by the rotary body 90. Therefore, it is preferable that the engagement between the pinion gears 94y to 94k and the drive rack 15 is released when the rotary body 90 rotates.

FIG. 12A illustrates a state in which the tray 80k is inside the rotary body 90 (a state in which the tray 80k is at the housing position). FIG. 12B illustrates a state in which the tray 80k has moved to the outside of the rotary body 90 (a state in which the tray 80k has moved to the take-out position).

As illustrated in FIG. 12A, when the tray 80k is inside the rotary body 90, the drive rack 15 is positioned at a lower portion in the apparatus body 1A. At this time, the drive rack 15 is retracted from the pinion gear 94k. Therefore, the rotary body 90 can be rotated without being obstructed by the drive rack 15. More specifically, the drive rack 15 can be retracted to the outside of the rotation locus of the rotary body 90 indicated by a dotted line in FIGS. 12A and 12B.

As described above, by rotationally driving the motor M2 in forward and reverse directions, the tray 80 attached to the rotary body 90 can be moved from the housing position to the take-out position and from the take-out position to the housing position with respect to the rotary body 90. That is, the driving device according to the present embodiment can drive each movement device of the rotary such that the toner cartridge moves from the mounting position to the retracted position, and can drive each movement device such that the toner cartridge moves from the retracted position to the mounting position.

Here, as described above, in the present embodiment, the movement amount of the tray 80 at the time of toner cartridge replacement is changed according to the size of the toner cartridge 70. Specifically, as illustrated in FIGS. 7A and 7B, the movement distance L1 when the black tray 80k moves from the housing position to the take-out position is longer than the movement distance L2 when the other trays 80y to 80c move from the housing positions to the take-out positions.

Therefore, in the present embodiment, when the toner cartridges 70y to 70k move from the mounting positions to the retracted positions, a value obtained by dividing a speed of the rack portion 83k by a speed of the drive rack 15 is larger than a value obtained by dividing a speed of each of the rack portions 83y to 83c by the speed of the drive rack 15.

For example, as illustrated in FIG. 10, the pinion gear 94y is a stepped gear, and a pitch circle radius of a small-diameter gear 942 meshing with the rack portion 83y is smaller than a pitch circle radius of a large-diameter gear 941 meshing with the drive rack 15. The pinion gears 94m and 94 c are similarly stepped gears. On the other hand, the pinion gear 94k has the same pitch circle radius at a portion meshing with the drive rack 15 and a portion meshing with the rack portion 83k. At this time, the pitch circle radius of the pinion gear 94k can be the same as the pitch circle radius of the large-diameter gear 941 of each of the pinion gears 94y to 94c. With such a configuration, even if the movement distance of the drive rack 15 is the same, the movement distance of the rack portion 83k can be larger than the movement distances of the other rack portions 83y to 83c. That is, the movement distance L1 when the black tray 80k moves from the housing position to the take-out position can be longer than the movement distance L2 when the other trays 80y to 80c move from the housing positions to the take-out positions.

Further, since the pinion gears 94y to 94c are stepped gears, the movement distance L1 of the tray 80k can be longer than the movement distance L2 of the other trays 80y to 80c in a configuration in which the pinion gears 94y to 94k receive the driving force from the same drive rack 15.

Instead of (or in combination with) the configuration in which the pinion gears 94y to 94c are stepped gears, the pinion gear 94k may be a stepped gear. In this case, it is sufficient if a portion of the pinion gear 94k that meshes with the drive rack 15 is a small-diameter gear, and a portion of the pinion gear 94k that meshes with the rack portion 83k is a large-diameter gear having a larger pitch circle radius than the small-diameter gear. The stepped gear is an example of a speed reduction mechanism, and may be replaced with a known speed reduction mechanism in which a movement amount of a member on an output side (tray 80 side) is smaller than a movement amount of a member on an input side (driving source side).

A movement amount of the drive rack 15 when moving the toner cartridge 70k from the mounting position to the retracted position may be larger than a movement amount of the drive rack 15 when moving the toner cartridges 70y to 70c from the mounting positions to the retracted positions.

Meanwhile, by reducing a distance by which the toner cartridge 70 moves from the mounting position to the retracted position, a movement time of the toner cartridge 70 can be shortened, and a time for the user to wait for the movement of the toner cartridge 70 can be shortened. If the movement amount of the drive rack 15 for the toner cartridge 70k is larger than the movement amount of the drive rack 15 for the toner cartridges 70y to 70c as described above, a time for the user to wait for the movement of the toner cartridges 70y to 70c can be shortened.

With the above configuration, the movement distance L1 can be made longer than the movement distance L2. These configurations can be used in combination.

### Positional Relationship Among Scanner, Intermediate Transfer Unit, Cleaning Unit, and Rotary Body

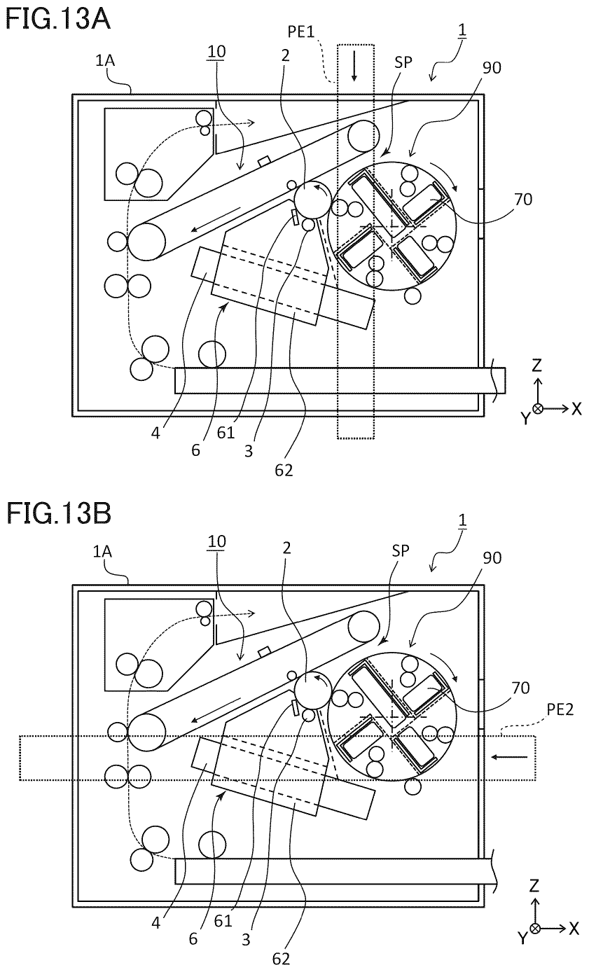

Next, a positional relationship among the scanner 4, the intermediate transfer unit 10, the cleaning unit 6, and the rotary body 90 will be described with reference to FIGS. 13A and 13B. FIGS. 13A and 13B are cross-sectional views illustrating a cross-sectional configuration of the image forming apparatus 1.

As illustrated in FIGS. 13A and 13B, the cleaning unit 6 includes the cleaning blade 61 serving as a collection member that collects the waste toner adhering to the photosensitive drum 2 after the toner image is transferred from the photosensitive drum 2, and the waste toner accommodating portion 62. The waste toner accommodating portion 62 accommodates the waste toner removed from the surface of the photosensitive drum 2 by the cleaning blade 61. The cleaning blade 61 is made of, for example, urethane rubber, and scrapes off the waste toner adhering to the surface of the photosensitive drum 2 by an edge portion of the cleaning blade 61. A material and a shape of the cleaning blade 61 are not particularly limited, and the cleaning blade 61 may be formed of a sponge, a brush, or the like.

The rotary body 90, the photosensitive drum 2, the charging roller 3, and the cleaning blade 61 are disposed in a space SP between the intermediate transfer unit 10 and the scanner 4 in a direction of gravity, that is, a direction (−Z direction) opposite to the Z direction. Then, the intermediate transfer unit 10, the rotary body 90, and the scanner 4 partially overlap one another when viewed in the −Z direction, and the intermediate transfer unit 10, the rotary body 90, and the scanner 4 are arranged in this order in the −Z direction, as indicated by a broken line region PE1 in FIG. 13A.

Further, the rotary body 90, the scanner 4, and the intermediate transfer unit 10 partially overlap one another when viewed in the −X direction, and the rotary body 90, the scanner 4, and the intermediate transfer unit 10 are arranged in this order in the −X direction, as indicated by a broken line region PE2 in FIG. 13B. The image forming apparatus 1 can be reduced in size by arranging the scanner 4, the intermediate transfer unit 10, the cleaning unit 6, and the rotary body 90 in this manner. In addition, the toner cartridge 70 mounted on the rotary body 90 can be easily replaced from the front surface (front side) side of the apparatus body 1A.

### Positional Relationship Between Scanner and Waste Toner Accommodating Portion

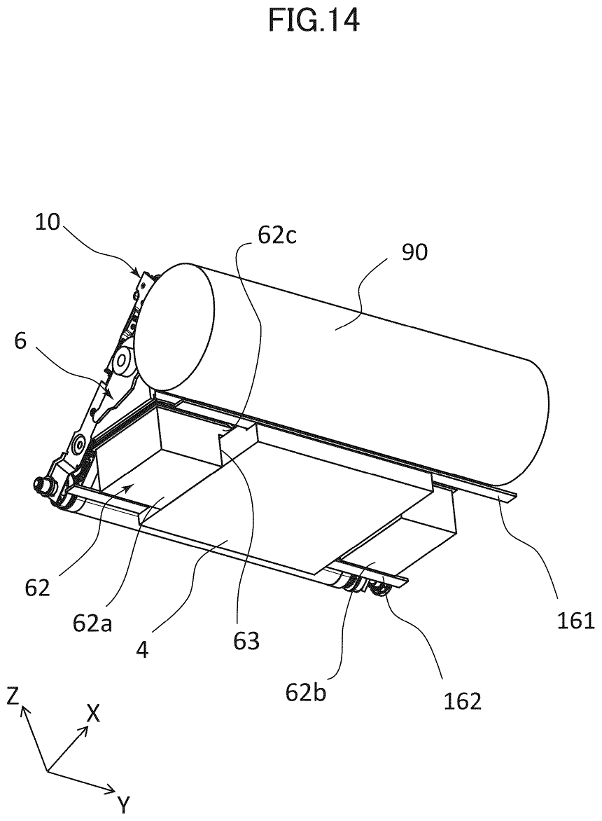

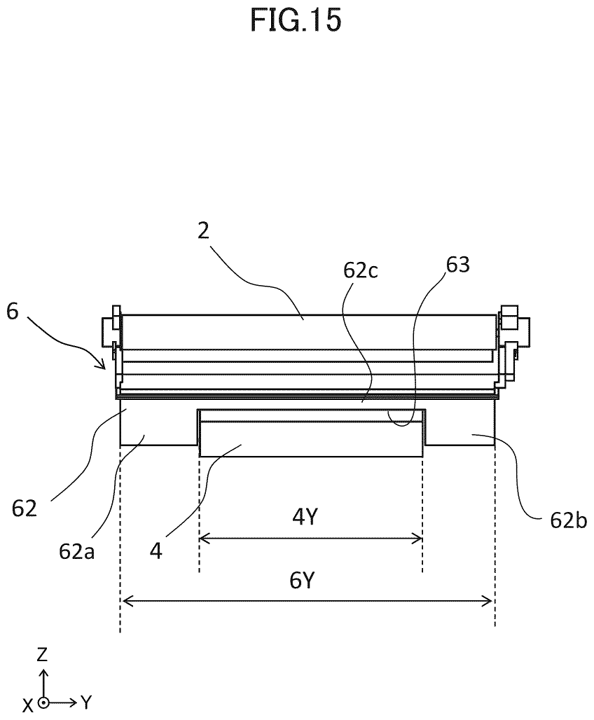

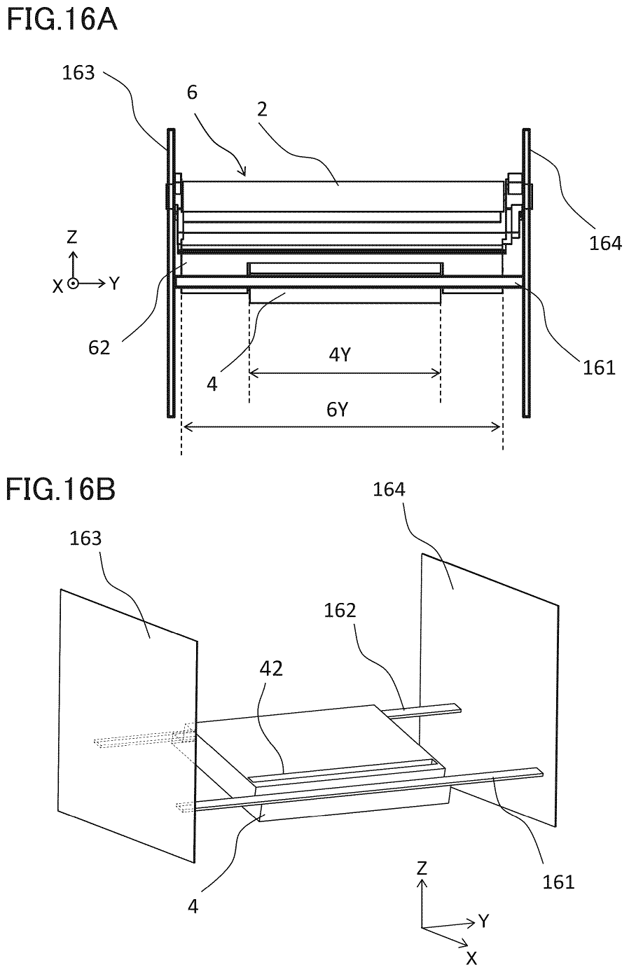

Next, a positional relationship between the scanner 4 and the waste toner accommodating portion 62 will be described with reference to FIGS. 13A to 16B. FIG. 14 is a perspective view illustrating the intermediate transfer unit 10, the cleaning unit 6, and the scanner 4. FIG. 15 is a front view illustrating the cleaning unit 6 and the scanner 4. FIG. 16A is a front view illustrating a support configuration of the scanner 4, and FIG. 16B is a perspective view illustrating the support configuration of the scanner 4.

As illustrated in FIGS. 13A to 15, the cleaning unit 6 is disposed adjacent to the photosensitive drum 2. The waste toner accommodating portion 62 of the cleaning unit 6 includes a first waste toner chamber 62a and a second waste toner chamber 62b disposed at a position different from that of the first waste toner chamber 62a in the Y direction. The waste toner accommodating portion 62 includes a connecting chamber 62c that connects the first waste toner chamber 62a to the second waste toner chamber 62b, and all of the first waste toner chamber 62a, the second waste toner chamber 62b, and the connecting chamber 62c can accommodate the waste toner.

The toner removed from the photosensitive drum 2 by the cleaning blade 61 is conveyed from the vicinity of the cleaning blade 61 to the waste toner accommodating portion 62 by gravity or am action of a conveying screw (not illustrated). The waste toner accommodating portion 62 is arranged so as to at least partially overlap the scanner 4 when viewed in the −Z direction. The waste toner accommodating portion 62 is arranged so as to at least partially overlap the scanner 4 when viewed in the Y direction.

More specifically, the first waste toner chamber 62a and the second waste toner chamber 62b are each arranged so as to at least partially overlap the scanner 4 when viewed in the Y direction. The connecting chamber 62c is arranged so as to overlap the scanner 4 in the Y direction. In the present embodiment, the connecting chamber 62c is arranged so as not to overlap the scanner 4 when viewed in the Y direction, but the present technology is not limited thereto. For example, the connecting chamber 62c may be arranged such that a part of the connecting chamber 62c overlaps the scanner 4 when viewed in the Y direction.

At this time, as illustrated in FIG. 15, a length 4Y of the scanner 4 in the Y direction is smaller than a length 6Y of the waste toner accommodating portion 62 in the Y direction. The scanner 4 is disposed in a recess 63 formed by the first waste toner chamber 62a, the second waste toner chamber 62b, and the connecting chamber 62c.

As illustrated in FIGS. 16A and 16B, the apparatus body 1A (FIG. 1) includes side plates 163 and 164 which are parts of a frame of the apparatus body 1A. The side plates 163 and 164 extend along an X-Z plane and are arranged so as to be separated from each other in the X direction. The side plates 163 and 164 rotatably support the photosensitive drum 2. The side plates 163 and 164 are connected by support stays 161 and 162 extending in the Y direction. The scanner 4 is supported by the support stays 161 and 162.

As described above, the waste toner accommodating portion 62 is arranged so as to at least partially overlap the scanner 4 when viewed in the Y direction, so that the image forming apparatus 1 can be reduced in size in the Z direction and the X direction. In addition, it is possible to increase a volume of the waste toner accommodating portion 62 while reducing the size of the image forming apparatus 1.

For example, there is a possibility that the toner removed from the photosensitive drum 2 by the cleaning blade 61 scatters in the apparatus body 1A when the waste toner accommodating portion 62 is fully filled with the toner. Therefore, the user needs to replace the cleaning unit 6 or discharge the toner in the waste toner accommodating portion 62 to the outside before the waste toner accommodating portion 62 is fully filled with the toner. However, in the present embodiment, the volume of the waste toner accommodating portion 62 can be increased while reducing the size of the image forming apparatus 1, so that maintenance frequency for the waste toner accommodating portion 62 can be reduced.

### First Modified Example

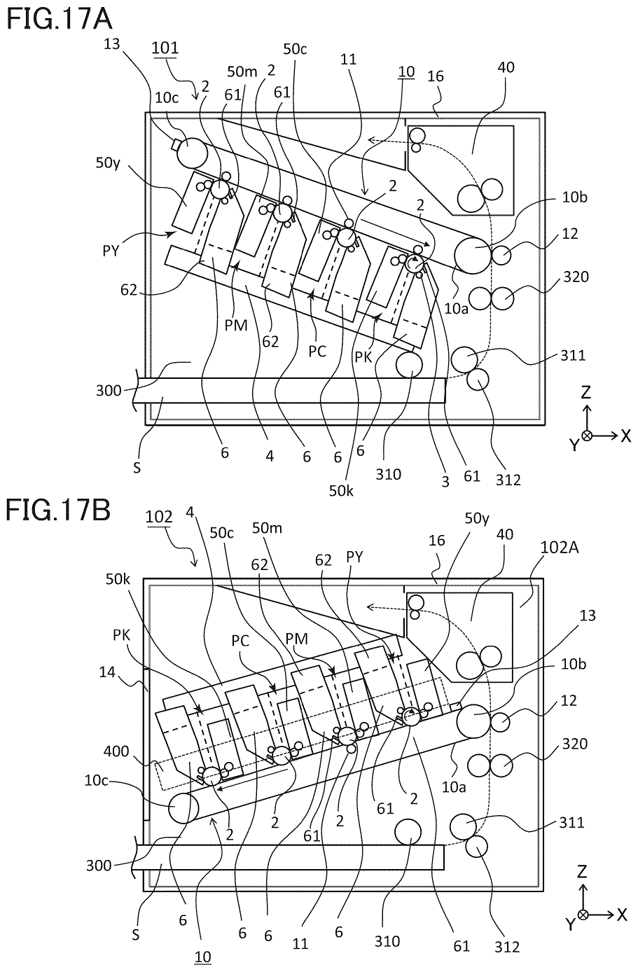

FIG. 17A is a cross-sectional view illustrating an image forming apparatus 101 according to a first modified example of the present embodiment. In the first modified example, a configuration similar to that of the present embodiment will be described in a manner of omitting illustration or attaching the same reference numerals in the drawings. The image forming apparatus 101 according to the first modified example is not a rotary type but a tandem type laser beam printer. That is, as illustrated in FIG. 17A, the image forming apparatus 101 includes four process cartridges PY, PM, PC, and PK instead of the rotary unit 90U, the photosensitive drum 2, and the cleaning unit 6 of the above-described embodiment. The process cartridges form toner images of respective colors of yellow, magenta, cyan, and black, respectively. Each process cartridge includes a photosensitive drum 2, a developing unit 50, and a cleaning unit 6, and the toner image formed on the photosensitive drum 2 of each process cartridge is transferred to an intermediate transfer belt 10a in a superimposed manner.

For example, the process cartridge PY serving as a first process unit includes the photosensitive drum 2 serving as a first photosensitive drum, a first developing unit 50y that develops a first electrostatic latent image formed on the photosensitive drum 2 as a first toner image, and the cleaning unit 6. The cleaning unit 6 includes a cleaning blade 61 serving as a first collection member that collects waste toner adhering to the photosensitive drum 2 after the first toner image is transferred from the photosensitive drum 2, and a waste toner accommodating portion 62 serving as a first waste toner accommodating portion that accommodates the waste toner collected by the cleaning blade 61. The process cartridge PM serving as a second process unit includes the photosensitive drum 2 serving as a second photosensitive drum, a second developing unit 50m that develops a second electrostatic latent image formed on the photosensitive drum 2 as a second toner image, and the cleaning unit 6. The cleaning unit 6 includes the cleaning blade 61 serving as a second collection member that collects the waste toner adhering to the photosensitive drum 2 after the second toner image is transferred from the photosensitive drum 2, and the waste toner accommodating portion 62 serving as a second waste toner accommodating portion that accommodates the waste toner collected by the cleaning blade 61. An intermediate transfer unit 10 includes the intermediate transfer belt 10a and four primary transfer rollers 11 corresponding to the photosensitive drums 2 of the respective process cartridges. For example, the intermediate transfer unit 10 includes the primary transfer roller 11 serving as a first transfer roller that transfers the first toner image formed on the photosensitive drum 2 of the process cartridge PY to the intermediate transfer belt 10a. In addition, the intermediate transfer unit 10 includes the primary transfer roller 11 serving as a second transfer roller that transfers the second toner image formed on the photosensitive drum 2 of the process cartridge PM to the intermediate transfer belt 10a.

Developing units 50y, 50m, 50c, and 50k are detachably supported by side plates 163 and 164 (see FIGS. 16A and 16B), and are configured to be insertable and removable through an opening provided on the side plate 163 disposed on the-Y side. The developing units 50y, 50m, 50c, and 50k may be inserted and removed integrally with the process cartridges PY, PM, PC, and PK.

In the first modified example, the intermediate transfer unit 10 is disposed above the process cartridges PY, PM, PC, and PK and a scanner 4. The respective waste toner accommodating portions (62) of the process cartridges PY, PM, PC, and PK are arranged so as to at least partially overlap the scanner 4 when viewed in the Y direction. As a result, effects similar to those according to the present embodiment can be obtained.

### Second Modified Example

FIG. 17B is a cross-sectional view illustrating an image forming apparatus 102 according to a second modified example of the present embodiment. In the second modified example, a configuration similar to that of the first modified example will be described in a manner of omitting illustration or attaching the same reference numerals in the drawings. The image forming apparatus 102 according to the second modified example is a tandem laser beam printer as in the first modified example. That is, as illustrated in FIG. 17B, the image forming apparatus 102 includes four process cartridges PY, PM, PC, and PK. In the second modified example, an intermediate transfer unit 10 is disposed below the process cartridges PY, PM, PC, and PK and a scanner 4.

The process cartridges PY, PM, PC, and PK are supported by a drawer unit 400, and the drawer unit 400 is supported so as to be drawable in the −X direction with respect to an apparatus body 102A of the image forming apparatus 102. The apparatus body 102A includes an openable and closable door 140 provided on a side surface on the −X side, and the drawer unit 400 can be drawn in the −X direction from the apparatus body 102A in a state in which the door 140 is opened. Then, the process cartridges PY, PM, PC, and PK can be attached to and detached from the drawer unit 400 in a state in which the drawer unit 400 is drawn to the outside of the apparatus body 102A.

In the present modified example, respective waste toner accommodating portions (62) of the process cartridges PY, PM, PC, and PK are also arranged so as to at least partially overlap the scanner 4 when viewed in the Y direction. As a result, effects similar to those according to the present embodiment can be obtained.

### Positional Relationship Between Passage Portion of Scanner and Discharge Opening of Toner Cartridge

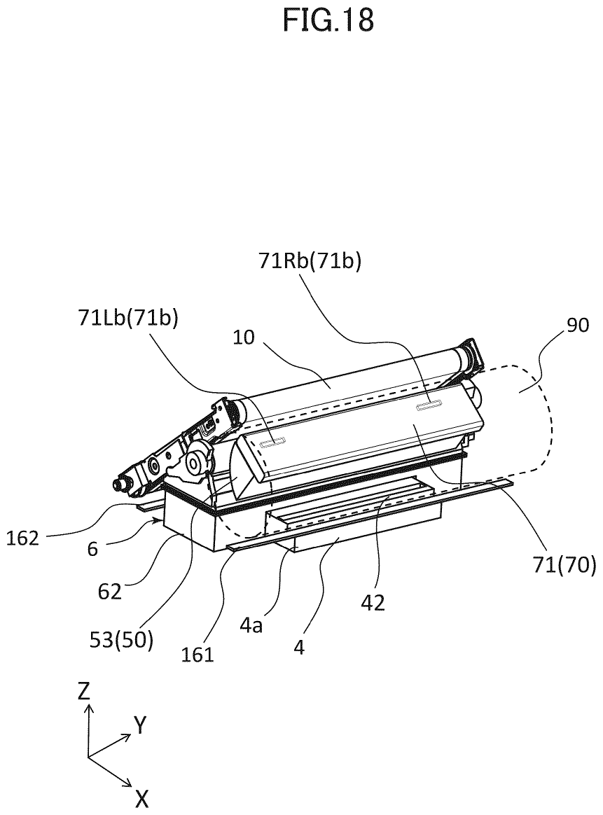

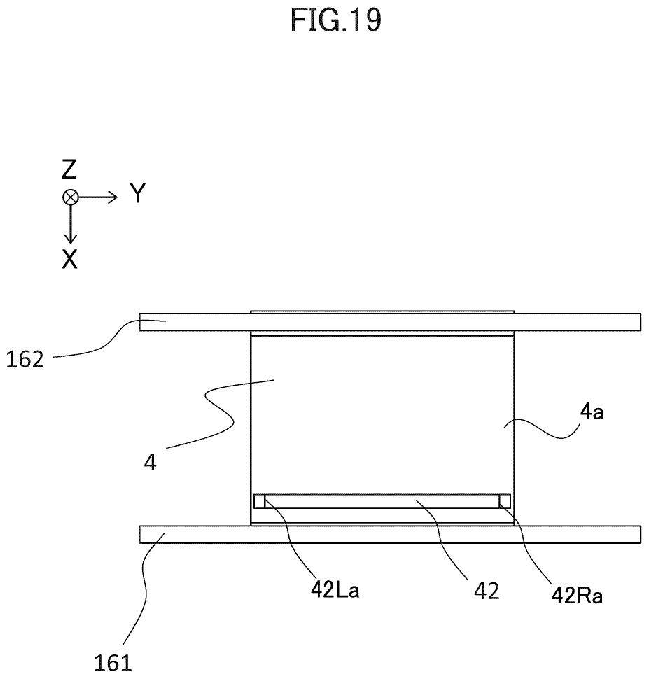

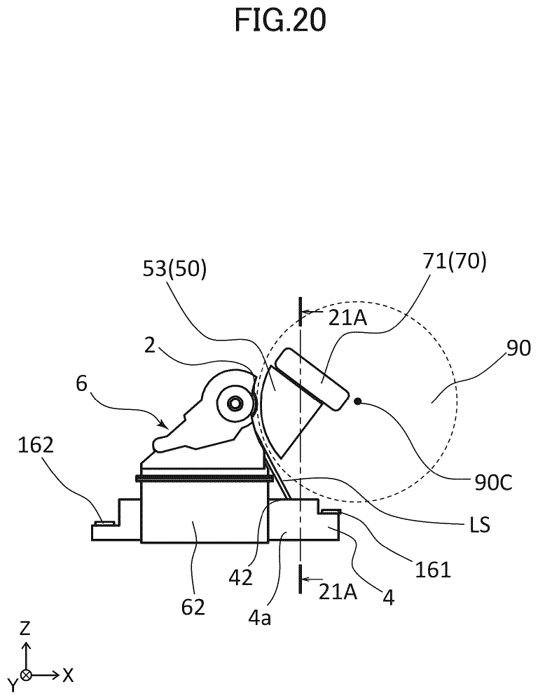

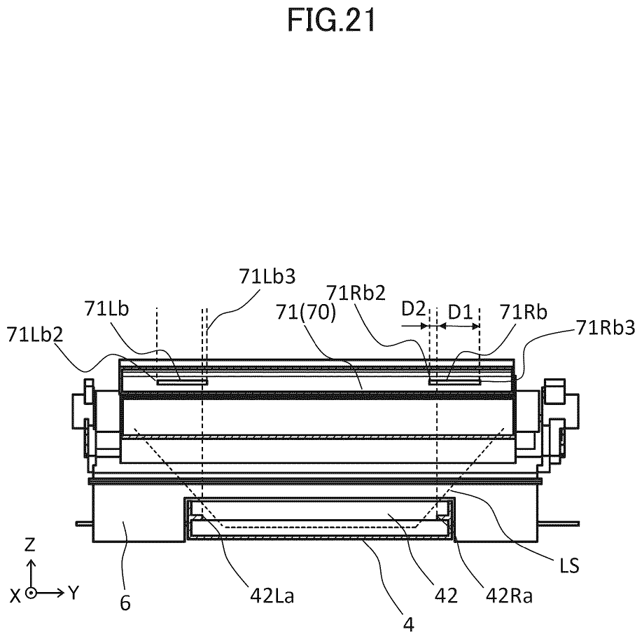

Next, a positional relationship between a passage portion 42 of the scanner 4 and a discharge opening 71b of the toner cartridge 70 will be described with reference to FIGS. 18 to 21. FIG. 18 is a perspective view illustrating the scanner 4 and the toner cartridge 70. FIG. 19 is a plan view illustrating the passage portion 42 of the scanner 4. FIG. 20 is a side view illustrating the scanner 4 and the toner cartridge 70. FIG. 21 is a cross-sectional view illustrating a cross section taken along 21A-21A of FIG. 20.

As illustrated in FIGS. 3 and 18, the discharge opening 71b is formed in the toner frame body 71 of the toner cartridge 70. In addition, the reception opening 53b facing the discharge opening 71b is formed in the developing frame body 53 of the developing unit 50. The discharge opening 71b is an example of a toner discharge port through which the toner supplied to the developing side accommodating portion 53a in the developing frame body 53 passes. In the present embodiment, two discharge openings 71b are provided at positions different from each other in the Y direction in the toner cartridge 70. Hereinafter, the discharge opening 71b on the +Y side will be described as a discharge opening 71Rb, and the discharge opening 71b on the −Y side will be described as a discharge opening 71Lb.

As illustrated in FIGS. 18 to 20, the scanner 4 includes a scanner casing 4a serving as a casing, and the passage portion 42 provided in the scanner casing 4a and through which laser light LS serving as light emitted toward the photosensitive drum 2 passes. The scanner 4 includes a laser oscillation unit (not illustrated) that is provided in the scanner casing 4a and oscillates the laser light LS. The passage portion 42 is disposed below the rotation axis 90C of the rotary body 90. In the present embodiment, the passage portion 42 is implemented by an opening portion provided in the scanner casing 4a, but is not limited thereto. For example, the passage portion 42 may be implemented by a transparent portion capable of transmitting the laser light LS. A portion of the scanner casing 4a other than the passage portion 42 is implemented by a member that does not transmit laser light.

As illustrated in FIG. 19, the passage portion 42 extends in the Y direction. The passage portion 42 has a downstream end 42Ra and an upstream end 42La in the Y direction. The Y direction serving as a predetermined direction can also be said to be a direction from a first side (−Y side) toward a second side (+Y side) in the rotation axis direction of the rotary body 90.

As illustrated in FIG. 21, the discharge openings 71Rb and 71Lb extend in the Y direction. The discharge opening 71Rb serving as a first toner discharge port has a downstream end 71Rb3 and an upstream end 71Rb2 in the Y direction. The downstream end 71Rb3 is positioned at a position farther from the center of the toner image formed on the photosensitive drum 2 than the upstream end 71R2 in the Y direction. Similarly, the discharge opening 71Lb serving as a second toner discharge port has a downstream end 71Lb3 and an upstream end 71Lb2 in the Y direction. The upstream end 71Lb2 is positioned at a position farther from the center of the toner image formed on the photosensitive drum 2 than the downstream end 71Lb3 in the Y direction.

The downstream end 71Rb3 of the discharge opening 71Rb is positioned downstream of the downstream end 42Ra of the passage portion 42 in the Y direction. In the present embodiment, the upstream end 71Rb2 of the discharge opening 71Rb is positioned upstream of the downstream end 42Ra of the passage portion 42 in the Y direction. The upstream end 71Lb2 of the discharge opening 71Lb is positioned upstream of the upstream end 42La of the passage portion 42 in the Y direction. In the present embodiment, the downstream end 71Lb3 of the discharge opening 71Lb is positioned downstream of the upstream end 42La of the passage portion 42 in the Y direction. Furthermore, a distance D1 between the downstream end 71Rb3 of the discharge opening 71Rb and the downstream end 42Ra of the passage portion 42 is longer than a distance D2 between the upstream end 71Rb2 of the discharge opening 71Rb and the downstream end 42Ra of the passage portion 42 in the Y direction.

As described above, in the present embodiment, at least partial regions of the discharge openings 71Rb and 71Lb are disposed at positions not overlapping the passage portion 42 of the scanner 4 in the Y direction. More specifically, in the Y direction, the downstream end 71Rb3 of the discharge opening 71Rb is positioned downstream of the downstream end 42Ra of the passage portion 42, and the upstream end 71Lb2 of the discharge opening 71Lb is positioned upstream of the upstream end 42La of the passage portion 42. Therefore, it is possible to reduce an amount of the toner that falls on the passage portion 42 of the scanner 4 even when the toner falls downward from between the discharge opening 71b and the reception opening 53b. Therefore, in a case where the passage portion 42 is the opening portion, it is possible to reduce an amount of the toner entering the scanner casing 4a of the scanner 4 and to suppress deterioration in performance of the scanner 4. In a case where the passage portion 42 is the transparent portion, it is possible to reduce an amount of the toner adhering to the passage portion 42 and to suppress deterioration in performance of the scanner 4.

### Second Embodiment

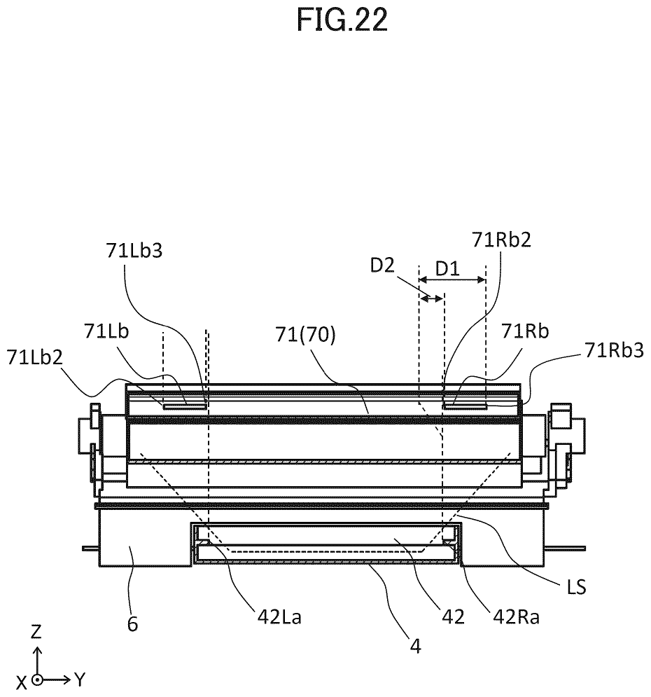

Next, an image forming apparatus according to a second embodiment will be described. The second embodiment differs from the first embodiment in a positional relationship between a passage portion 42 of a scanner 4 and a discharge opening 71b of a toner cartridge 70. Therefore, a configuration similar to that of the first embodiment will be described in a manner of omitting illustration or attaching the same reference numerals in the drawings. FIG. 22 is a cross-sectional view illustrating a cross section taken along 21A-21A of FIG. 20 according to the second embodiment.

In the second embodiment, as illustrated in FIG. 22, a downstream end 71Rb3 and an upstream end 71Rb2 of a discharge opening 71Rb are positioned downstream of a downstream end 42Ra of the passage portion 42. A downstream end 71Lb3 and an upstream end 71Lb2 of a discharge opening 71Lb are positioned upstream of an upstream end 42La of the passage portion 42. That is, in the present embodiment, the entire discharge opening 71Rb is positioned downstream of the downstream end 42Ra of the passage portion 42, and the entire discharge opening 71Lb is positioned upstream of the upstream end 42La of the passage portion 42. In the present embodiment, a distance D1 between the downstream end 71Rb3 of the discharge opening 71Rb and the downstream end 42Ra of the passage portion 42 is also longer than a distance D2 between the upstream end 71Rb2 of the discharge opening 71Rb and the downstream end 42Ra of the passage portion 42 in the Y direction.

As described above, in the present embodiment, the entire discharge openings 71Rb and 71Lb are disposed at positions not overlapping the passage portion 42 of the scanner 4 in the Y direction. Therefore, it is possible to reduce an amount of a toner that falls on the passage portion 42 of the scanner 4 even when the toner falls downward from between the discharge opening 71b and a reception opening 53b. Therefore, it is possible to further suppress deterioration in performance of the scanner 4.

### Other Embodiments

In the first and second embodiments described above, the waste toner accommodating portion 62 includes the first waste toner chamber 62a, the second waste toner chamber 62b, and the connecting chamber 62c, and the scanner 4 is disposed in the recess 63 of the waste toner accommodating portion 62, but the present technology is not limited thereto. For example, the waste toner accommodating portion 62 does not have to have the recess 63. In this case, for example, the waste toner accommodating portion 62 may be arranged so as to at least partially overlap the scanner 4 when viewed in the Y direction, and may be arranged so as to be offset from the scanner 4 in the Y direction. As described above, the shape and material of the waste toner accommodating portion 62 are not limited as long as the waste toner accommodating portion 62 is arranged so as to at least partially overlap the scanner 4 when viewed in the Y direction.

In the present embodiment, the toner cartridge 70 includes the two discharge openings 71Rb and 71Lb, but the present technology is not limited thereto. For example, the number of discharge openings (71b) provided in the toner cartridge 70 may be one or three or more.

In the first and second embodiments described above, a configuration in which the rotary body 90 includes the four developing units 50y to 50k and the toners of four colors are used to form a color image has been described. However, the rotary body 90 may include three or less developing units, or may include five or more developing units. In these cases, the number and arrangement of the trays and the toner cartridges can be appropriately changed according to the number of developing units. For example, in the first and second embodiments described above, a configuration in which the four toner cartridges 70y to 70k is attachable to and detachable from the rotary body 90 has been exemplified. However, the rotary body 90 may include only one developing unit 50k, and only one toner cartridge 70k may be mounted on the rotary body 90. In this case, the rotary body 90 rotates clockwise in FIG. 1 around the rotation axis 90C, and can sequentially take the black replacement posture and the black developing posture.

In the first and second embodiments described above, a configuration in which the rotary body 90 includes the four developing units 50y to 50k and the toners of four colors are used to form a color image has been described. However, the rotary body 90 may include a plurality of developing units capable of performing image formation using toners of the same color. For example, the rotary body 90 may include four black developing units 50k, and four toner cartridges 70k may be mounted on the rotary body 90.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-070299, filed Apr. 24, 2024 and Japanese Patent Application No. 2024-070298, filed Apr. 24, 2024, which are hereby incorporated by reference herein in their entirety.

What is claimed is:

1. An image forming apparatus comprising:
a photosensitive drum;
an exposure device configured to expose a surface of the photosensitive drum to form an electrostatic latent image on the surface;
a rotary configured to rotate and including:
a developing roller configured to develop the electrostatic latent image as a toner image; and
an accommodating frame including an accommodating portion configured to accommodate toner to be supplied to the developing roller; and
a toner cartridge configured to accommodate the toner, move between a mounting position and a retracted position where the toner cartridge is retracted from the mounting position with respect to the accommodating frame, and supply the toner to the accommodating portion in a state of being at the mounting position, the toner cartridge being detachably attached to the rotary,
wherein the exposure device includes a casing and a passage portion which is provided in the casing and disposed below a rotation axis of the rotary and through which light emitted toward the photosensitive drum passes,
the toner cartridge includes a toner discharge port through which the toner supplied to the accommodating portion of the rotary passes,
a direction from a first side toward a second side in a rotation axis direction of the rotary is defined as a predetermined direction, and
a downstream end of the toner discharge port is positioned downstream of a downstream end of the passage portion in the predetermined direction.

2. The image forming apparatus according to claim 1, wherein a distance between the downstream end of the toner discharge port and the downstream end of the passage portion is longer than a distance between an upstream end of the toner discharge port and the downstream end of the passage portion in the predetermined direction.

3. The image forming apparatus according to claim 1, wherein an upstream end of the toner discharge port is positioned upstream of the downstream end of the passage portion in the predetermined direction.

4. The image forming apparatus according to claim 1, wherein an upstream end of the toner discharge port is positioned downstream of the downstream end of the passage portion in the predetermined direction.

5. The image forming apparatus according to claim 1, wherein the toner discharge port is a first toner discharge port,
the toner cartridge includes a second toner discharge port disposed upstream of the first toner discharge port in the predetermined direction and configured to supply the toner to the accommodating portion of the rotary, and
an upstream end of the second toner discharge port is positioned upstream of an upstream end of the passage portion in the predetermined direction.

6. The image forming apparatus according to claim 1, wherein the passage portion is an opening portion provided in the casing.

7. The image forming apparatus according to claim 1, wherein the passage portion is a transparent portion configured to transmit the light emitted toward the photosensitive drum.

8. The image forming apparatus according to claim 1, further comprising a support member movably supported with respect to the accommodating frame such that the toner cartridge moves from the mounting position to the retracted position.

9. The image forming apparatus according to claim 8, further comprising:
a driving source;
a pinion gear configured to be driven by a driving force from the driving source; and
a rack gear provided on the support member and configured to mesh with the pinion gear to move integrally with the support member.

10. An image forming apparatus comprising:
a photosensitive drum;
an exposure device configured to expose a surface of the photosensitive drum to form an electrostatic latent image on the surface;
a rotary configured to rotate and including:
a developing roller configured to develop the electrostatic latent image as a toner image; and
an accommodating frame including an accommodating portion configured to accommodate toner to be supplied to the developing roller;
a toner cartridge configured to accommodate the toner, move between a mounting position and a retracted position where the toner cartridge is retracted from the mounting position with respect to the accommodating frame, and supply the toner to the accommodating portion in a state of being at the mounting position, the toner cartridge being detachably attached to the rotary;
a collection member configured to collect waste toner adhering to the photosensitive drum after the toner image is transferred from the photosensitive drum; and
a waste toner accommodating portion configured to accommodate the waste toner collected by the collection member,
wherein the waste toner accommodating portion is arranged so as to at least partially overlap the exposure device when viewed in a rotation axis direction of the photosensitive drum.

11. The image forming apparatus according to claim 10, wherein the waste toner accommodating portion includes:
a first waste toner chamber configured to accommodate the waste toner; and
a second waste toner chamber disposed at a position different from the first waste toner chamber in the rotation axis direction and configured to accommodate the waste toner,
the first waste toner chamber and the second waste toner chamber are each arranged so as to at least partially overlap the exposure device when viewed in the rotation axis direction, and
the exposure device is disposed between the first waste toner chamber and the second waste toner chamber in the rotation axis direction.

12. The image forming apparatus according to claim 11, wherein the waste toner accommodating portion includes a connecting chamber configured to connect the first waste toner chamber to the second waste toner chamber, and
the connecting chamber overlaps the exposure device in the rotation axis direction.

13. The image forming apparatus according to claim 10, further comprising an intermediate transfer unit to which the toner image is transferred from the photosensitive drum,
wherein the rotary, the photosensitive drum, and the collection member are disposed in a space between the intermediate transfer unit and the exposure device in a direction of gravity.

14. The image forming apparatus according to claim 13, wherein the intermediate transfer unit, the rotary, and the exposure device are arranged so as to at least partially overlap one another when viewed in the direction of gravity.

15. The image forming apparatus according to claim 13, wherein the intermediate transfer unit, the rotary, and the exposure device are arranged so as to at least partially overlap one another when viewed in a direction orthogonal to both the direction of gravity and the rotation axis direction of the photosensitive drum.

16. The image forming apparatus according to claim 10, further comprising a support member movably supported with respect to the accommodating frame such that the toner cartridge moves from the mounting position to the retracted position.

17. The image forming apparatus according to claim 16, further comprising:
a driving source;
a pinion gear configured to be driven by a driving force from the driving source; and
a rack gear provided on the support member and configured to mesh with the pinion gear to move integrally with the support member.

18. An image forming apparatus comprising:
a first process unit including:
a first photosensitive drum;
a first developing unit configured to develop a first electrostatic latent image formed on the first photosensitive drum as a first toner image;
a first collection member configured to collect waste toner adhering to the first photosensitive drum after the first toner image is transferred from the first photosensitive drum; and
a first waste toner accommodating portion configured to accommodate the waste toner collected by the first collection member;
a second process unit including:
a second photosensitive drum;
a second developing unit configured to develop a second electrostatic latent image formed on the second photosensitive drum as a second toner image;
a second collection member configured to collect waste toner adhering to the second photosensitive drum after the second toner image is transferred from the second photosensitive drum; and
a second waste toner accommodating portion configured to accommodate the waste toner collected by the second collection member;
an exposure device configured to expose the first photosensitive drum and the second photosensitive drum to form the first electrostatic latent image and the second electrostatic latent image; and
an intermediate transfer unit including:
an intermediate transfer body;
a first transfer roller configured to transfer the first toner image to the intermediate transfer body; and
a second transfer roller configured to transfer the second toner image to the intermediate transfer body,
wherein the first waste toner accommodating portion and the second waste toner accommodating portion are each arranged so as to at least partially overlap the exposure device when viewed in a rotation axis direction of the first photosensitive drum.

19. The image forming apparatus according to claim 18, wherein the intermediate transfer unit is disposed above the first process unit, the second process unit, and the exposure device.

20. The image forming apparatus according to claim 18, wherein the intermediate transfer unit is disposed below the first process unit, the second process unit, and the exposure device.
